(19) United States
(12) Patent Application Publication
(10) Pub. No.: US 2026/0184514 A1
(43) Pub. Date: Jul. 2, 2026

(54) METHODS OF OPERATING A CONVEYOR SYSTEM WITH CONVEYOR CONTROLLERS

(71) Applicant: Bastian Solutions, LLC, Carmel, IN (US)

(72) Inventors: Clinton Cooper, Westfield, IN (US); Daniel Patton Travis, Meridian, ID (US); Bradley Thomas Smith, Boise, ID (US); Jason Stuart Huckelberry, Fishers, IN (US); Bryan Robert Routt, Indianapolis, IN (US); Geoffrey William Schreiber, Collinsville, IL (US)

(73) Assignee: Bastian Solutions, LLC, Carmel, IN (US)

(21) Appl. No.: 19/544,347

(22) Filed: Feb. 19, 2026

Related U.S. Application Data
(63) Continuation-in-part of application No. 18/300,803, filed on Apr. 14, 2023, now Pat. No. 12,580,834.
Application No. 18/300,803 is a continuation of application No. PCT/US2021/071941, filed on Oct. 20, 2021.
(60) Provisional application No. 63/198,471, filed on Oct. 21, 2020.

(51) Int. Cl. B65G 43/02

(52) U.S. Cl. CPC B65G 43/02

(57) ABSTRACT

A sideband communication system has been developed for a conveyor system. A controller card controls the operation of a conveyor zone and communicates information about each conveyor in the conveyor zone. The controller card is assigned to control and monitor the operation of one or more of these zones of conveyors. The cards of adjacent zones are daisy-chained together to facilitate communication with one another and with other systems like a programmable logic controller (PLC). In addition to the standard controller area network (CAN) communication protocol, the controller cards further communicate amongst themselves using a sideband communication protocol that is outside the realm of the standard CAN communication protocol. The sideband communication protocol allows the cards to communicate with each other without interfering with normal network communications which provides additional capabilities such as automatic card self-identification.

### CROSS REFERENCE TO RELATED APPLICATIONS

This application is a continuation-in-part of U.S. patent application Ser. No. 18/300,803, filed Apr. 14, 2023, which is hereby incorporated by reference. U.S. patent application Ser. No. 18/300,803, filed Apr. 14, 2023, is a continuation of International Patent Application Number PCT/US2021/071941, filed Oct. 20, 2021, which are hereby incorporated by reference. International Patent Application Number PCT/US2021/071941, filed Oct. 20, 2021, claims the benefit of U.S. Patent Application No. 63/198,471, filed Oct. 21, 2020, which are hereby incorporated by reference.

### BACKGROUND

Conveyors are used in a wide variety of environments such as in manufacturing and warehouse environments. Maintenance and upkeep of conveyor systems is always a concern. For traditional conveyor controller systems, when a controller card fails and/or needs to be replaced, a technician has to manually program the replacement card by for example setting specific dipswitches on the card. This can be a time consuming and laborious process. Thus, there is a need for improvement in this field.

### SUMMARY

A unique controller card has been developed for use in conveyor systems. The controller card includes support for both 24V and 48V rollers without any change in the settings and/or configuration of the card. Similarly, the controller card further supports both older style alternating current (AC) systems, where a solenoid engages or disengages the conveyor from an AC motor used to power the conveyor, and newer direct current (DC) systems without requiring additional modifications. Some general components of the controller card include a sideband communication system, a data analytic system, and a roller detection system.

A unique sideband communication system has been developed for the conveyor controller cards. Electronic control units (ECUs) or nodes in the form of the controller cards control the operation of various sections of conveyors as well as communicate information about the conveyors and items transported by the conveyors. Typically, but not always, each card is assigned to control and monitor the operation of one or more sections of conveyors. In one form, the cards of adjacent conveyor sections are daisy chained together through a wired connection so as to facilitate communication with one another as well as with other systems like a programmable logic controller (PLC). The cards in one variation are connected together through RJ45 type Ethernet cables. In other examples, the cards can be operatively connected through wireless and/or wired type connections. Together, the cards form a controller area network (CAN). In addition to the standard CAN communication protocol, the controller cards further communicate amongst themselves using a sideband communication protocol that is outside the realm of the standard CAN communication protocol. The sideband communication protocol allows the controller cards to communicate with each other without interfering with normal network communications which in turn provides additional capabilities.

The sideband communication system further allows the cards to automatically self-identify such as during initial installation or maintenance. The status or identity of the card can be determined in a number of ways. For example, if the card does not sense a connection at an upstream Ethernet port of the card where the Ethernet cable for an upstream card is normally connected, the card can self-identify as being the first card in the daisy chain. The first card in other examples can self-identify when a specific sensor, such as a wake-up photo eye, is connected to the card. Once the first card has been identified, the remaining downstream cards are able to self-identify in a sequential or cascading fashion from the first card. For example, the second card in one form receives a signal, such as in the form of an address, identifier, and/or command, through the sideband protocol from an upstream card that the upstream card has been identified as being the first card. In response to receiving the signal, the immediate downstream card self-identifies as the second card, and using the sideband communication protocol, the newly self-identified second card communicates with the downstream card so that the third card can self-address or identify in a similar fashion. The last card in the line can self-identify as being the last card in the line in several ways. For instance, the last card can monitor the connection status of a downstream communication port of the card and/or monitor signals from other connected devices like sensors and/or motors.

During installation or maintenance of multiple cards, programming or setting the operational parameters for the individual cards can be a laborious process. The sideband communication system is configured to facilitate this programming of multiple cards at or nearly at the same time by propagating the settings of one card to the other cards. In one aspect, the sideband communication system allows for a user interface (UI) to propagate operating parameters or settings to all of the cards through the sideband communication protocol almost instantaneously, or in some cases, in a sequential manner. In one form, the UI includes a series of buttons and light emitting diodes (LEDs), and in other forms, the UI includes a touchscreen or other types of UIs. In one example, a user selects a parameter and holds down a button on the selection for a few seconds before a selection window asks if the user wants to propagate the parameters to all connected cards. Via the sideband communication protocol, the controller card transmits over the CAN the parameters to the other cards without having to program each separately.

The sideband communication system further allows cards to detect failures in neighboring cards. For example, when communication in a neighboring card is sporadic or even nonexistent, the card in one variation sends a notification to the appropriate equipment (e.g., a PLC, computer, etc.) and/or personnel of the potential card failure. In other variations, the card monitors signals and operating conditions of neighboring cards to determine their operational status. For instance, when an item is transferred from an upstream conveyor section controlled by an upstream card to a downstream conveyor section controlled by a downstream card and the downstream card does not signal receipt of the item back to the upstream card, either on a continuous or intermittent basis, the upstream card sends a notification of potential failure of the downstream card to the appropriate equipment and/or personnel.

In earlier conveyor controller systems, when a controller card failed and/or needed to be replaced, a technician had to manually program the replacement card by for example setting specific dipswitches on the card. This can be a time consuming and laborious process. The sideband communication system facilitates an automatic recovery mode or buddy capability that allows cards to be readily replaced in case of card failure or system maintenance. With this recovery capability, each card has memory for storing the settings of cards located immediately upstream and downstream from the card. The configuration information from the upstream and downstream cards in one example is communicated using the sideband communication protocol. When a failed card is replaced with a new card, the upstream and/or downstream card automatically transfers the previous configuration settings to the new card using the sideband channel, thus saving time, effort, and money during card replacement. With each card storing the settings for both the upstream and downstream cards, at least two adjacent control cards can be replaced and automatically programed by the upstream and downstream cards bookending the two adjacent cards.

The sideband communication system further allows scanner-less, zone-to-zone tracking of packages or other items along various conveyor sections or zones. The system in one form is configured to track packages in the conveyor zones by assigning virtual tracking numbers. Alternatively or additionally, the system receives a unique identifier for the package from a barcode and/or radio frequency identification (RFID) scanner located along an upstream conveyor zone. Once identified, the package can be tracked along various conveyor zones without the need for rescanning because the controller cards through the sideband communication protocol communicate the package identifiers when the packages are moved along and/or transferred from the various conveyor zones.

For instance, when a package is received on a conveyor section controlled by a card, the upstream card sends to the current conveyor section card the identifier for the package, and the current conveyor card stores the package identifier in memory. Based on the conveyor speed and information from sensors along the conveyor section as well as other factors, the card determines and tracks the location of the package on the conveyor section. Through the CAN, the card in one form transmits the package identifier (either virtual or actual identifier) as well as other information to a warehouse management system (WMS) or other system so that the package location is tracked throughout a facility. Before, during, or after the tracked package leaves the zone controlled by the card, the card transmits the package identifier to the downstream card so that the package can then be tracked along the downstream conveyor zone.

Several unique techniques have been further developed to facilitate communication and operation of conveyor systems. In one example, an unsolicited feedback mode or technique has been developed to reduce network traffic and congestion. With this technique, the individual controller cards only send unsolicited feedback messages to a programmable logic controller (PLC) or other device when events occur. This unsolicited feedback mode can be designated on a per-card basis. A follow-me mode has also been developed in which a leader controller card controls the operation of the remaining follower cards in a chain of cards. The leader card in essence instructs the other cards in the chain as to which direction to move or not. Various global programming modes or techniques have been developed to update multiple controller cards at the same time. For example, these global programming techniques allow firmware to be quickly flashed on multiple controller cards or factory resets can be quickly performed on multiple controller cards. In one variation, the global programming occurs in a sequential basis and in another variation, the global programming of the controller cards can occur in a parallel manner. This parallel global programming approach can help reduce network congestion as well as shorten update times. Still yet another technique concerns a jammed zone self-recovery method where the controller card is able to automatically resolve package jams in a jammed conveyor zone.

The systems and techniques as described and illustrated herein concern a number of unique and inventive aspects. Some, but by no means all, of these unique aspects are summarized below.

Aspect 1 generally concerns a conveyor system.

Aspect 2 generally concerns the conveyor system of any previous aspect including one or more controller cards that are dedicated to control individual conveyor zones.

Aspect 3 generally concerns the conveyor system of any previous aspect in which the controller cards are operatively connected to one another to form a network.

Aspect 4 generally concerns the conveyor system of any previous aspect in which the controller cards are configured to communicate with each other using a sideband communication protocol that is different from a standard communication protocol for the network.

Aspect 5 generally concerns the conveyor system of any previous aspect in which the controller cards are operatively connected via one or more communication cables.

Aspect 6 generally concerns the conveyor system of any previous aspect in which the communication cable includes a main communication channel and a sideband communication channel.

Aspect 7 generally concerns the conveyor system of any previous aspect in which the sideband communication channel is configured to communicate data using a RJ485 serial protocol.

Aspect 8 generally concerns the conveyor system of any previous aspect in which the controller cards each have an upstream port and a downstream port configured to respectively communicate with upstream and downstream controller cards.

Aspect 9 generally concerns the conveyor system of any previous aspect in which the controller cards are configured to automatically self-identify.

Aspect 10 generally concerns the conveyor system of any previous aspect in which the controller cards are configured to self-identify in a sequential manner based on a card identifier from an upstream controller card.

Aspect 11 generally concerns the conveyor system of any previous aspect in which the controller cards are configured to self-identify based on a port connection status.

Aspect 12 generally concerns the conveyor system of any previous aspect in which the controller cards are configured to self-identify based on a type of sensor connected to the controller cards.

Aspect 13 generally concerns the conveyor system of any previous aspect in which the sensor includes a wake-up photoeye.

Aspect 14 generally concerns the conveyor system of any previous aspect in which the controller cards have a user interface configured to propagate card settings to the other controller cards.

Aspect 15 generally concerns the conveyor system of any previous aspect in which the controller cards are configured to automatically detect failures of neighboring controller cards.

Aspect 16 generally concerns the conveyor system of any previous aspect in which the controller cards are configured to communicate card failures on behalf of the failed neighboring controller card.

Aspect 17 generally concerns the conveyor system of any previous aspect in which the controller cards are configured to detect card failures based on communication status of the neighboring controller card.

Aspect 18 generally concerns the conveyor system of any previous aspect in which the controller cards are configured to detect card failures based on veracity of operational conditions communicated by the neighboring controller cards.

Aspect 19 generally concerns the conveyor system of any previous aspect in which the controller cards are configured to automatically program neighboring replacement cards with settings from a replaced controller card.

Aspect 20 generally concerns the conveyor system of any previous aspect in which the controller cards have memory configured to stores settings from neighboring upstream and downstream controller cards.

Aspect 21 generally concerns the conveyor system of any previous aspect in which the conveyor system is configured to perform scanner-less zone-to-zone tracking of items transported via the conveyor system.

Aspect 22 generally concerns the conveyor system of any previous aspect in which the controller cards are configured to communicate identifiers for the items to a downstream controller card as the items transition to a downstream conveyor zone controlled by the downstream controller.

Aspect 23 generally concerns the conveyor system of any previous aspect in which the identifiers are virtual identifiers created by the controller cards.

Aspect 24 generally concerns the conveyor system of any previous aspect in which the controller cards are configured to communicate zone-to-zone tracking information to a warehouse management system (WMS).

Aspect 25 generally concerns the conveyor system of any previous aspect in which the controller cards include one or more inputs and/or outputs.

Aspect 26 generally concerns the conveyor system of any previous aspect including a programmable logic controller (PLC) configured to reconfigure the inputs and/or outputs of the controller cards.

Aspect 27 generally concerns the conveyor system of any previous aspect in which the PLC is adapted to reconfigure at least one of the controller cards over the network.

Aspect 28 generally concerns the conveyor system of any previous aspect in which the controller cards are configured to send a notification over the network to the PLC.

Aspect 29 generally concerns the conveyor system of any previous aspect including a computer configured to remotely flash the controller cards using a window based interface.

Aspect 30 generally concerns the conveyor system of any previous aspect including a network operatively connected to the controller cards.

Aspect 31 generally concerns the conveyor system of any previous aspect in which the controller cards are configured to reduce congestion on the network.

Aspect 32 generally concerns the conveyor system of any previous aspect in which the controller cards are configured to provide unsolicited feedback messages over the network.

Aspect 33 generally concerns the conveyor system of any previous aspect in which the controller cards are configured to operate in a follow-me mode.

Aspect 34 generally concerns the conveyor system of any previous aspect in which the controller cards include a leader controller card and one or more follower controller cards connected in a chain.

Aspect 35 generally concerns the conveyor system of any previous aspect in which the follower controller cards are configured to follow operation instructions from the leader controller card.

Aspect 36 generally concerns the conveyor system of any previous aspect in which the leader card is only able to communicate on behalf of the chain.

Aspect 37 generally concerns the conveyor system of any previous aspect in which the follower controller cards are configured to delay operation initiation by a delay value to avoid electrical overloads.

Aspect 38 generally concerns the conveyor system of any previous aspect in which the controller cards have a unique card address that includes a chain identifier and a card identifier.

Aspect 39 generally concerns the conveyor system of any previous aspect in which the controller cards have a zero-index mode where the controller cards are prevented from indexing upon bootup.

Aspect 40 generally concerns the conveyor system of any previous aspect in which the controller cards are configured to allow global programming via the network.

Aspect 41 generally concerns the conveyor system of any previous aspect in which the global programming includes flashing firmware on the controller cards.

Aspect 42 generally concerns the conveyor system of any previous aspect in which the global programming includes performing resets of the controller cards.

Aspect 43 generally concerns the conveyor system of any previous aspect in which the global programming includes neighbor restores of the controller cards.

Aspect 44 generally concerns the conveyor system of any previous aspect in which the global programming is configured to occur in a serial manner.

Aspect 45 generally concerns the conveyor system of any previous aspect in which the global programming is configured to occur in a parallel manner.

Aspect 46 generally concerns the conveyor system of any previous aspect in which the controller cards have a jammed zone self-recovery mode.

Aspect 47 generally concerns the conveyor system of any previous aspect in which the jammed zone self-recovery mode includes an operational time limit, a wait time limit, and a number of attempts limit.

Aspect 48 generally concerns a method.

Aspect 49 generally concerns the method of any previous aspect including receiving a selection of two or more selected controller cards of a conveyor system.

Aspect 50 generally concerns the method of any previous aspect including sending one or more packets over a network to the selected controller cards.

Aspect 51 generally concerns the method of any previous aspect including programming the selected control cards based on the packets from the network.

Aspect 52 generally concerns the method of any previous aspect in which the programming includes performing firmware updates of the selected controller cards.

Aspect 53 generally concerns the method of any previous aspect in which the programming includes performing memory resets of the selected controller cards.

Aspect 54 generally concerns the method of any previous aspect in which the programming includes performing neighbor restores of the selected controller cards.

Aspect 55 generally concerns the method of any previous aspect in which the programming includes designating the selected controller cards as communicating via an unsolicited feedback mode.

Aspect 56 generally concerns the method of any previous aspect in which the programming the selected control cards occurs in a sequential manner.

Aspect 57 generally concerns the method of any previous aspect in which the sending includes addressing the packets to unique addresses for the selected controller cards.

Aspect 58 generally concerns the method of any previous aspect in which the programming the selected control cards occurs in a parallel manner.

Aspect 59 generally concerns the method of any previous aspect in which the sending includes addressing the packets to a global address.

Aspect 60 generally concerns the method of any previous aspect including monitoring a status of a conveyor zone with a controller card.

Aspect 61 generally concerns the method of any previous aspect including determining a change in the status of the conveyor zone with the controller card.

Aspect 62 generally concerns the method of any previous aspect including sending a message from the controller card over a network in response to the determining the change in the status of the conveyor zone.

Aspect 63 generally concerns the method of any previous aspect in which the monitoring the status of the conveyor zone includes monitoring the conveyor zone with a zone sensor.

Aspect 64 generally concerns the method of any previous aspect including receiving at least one packet from the network that programs the controller card to communicate via an unsolicited feedback mode before the sending the message.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a conveyor system.

FIG. 2 is a block diagram of a conveyor system.

FIG. 3 is a block diagram of a power system.

FIG. 4 is a block diagram of a communication system.

FIG. 5 is a block diagram of a sideband communication system.

FIG. 6 is a perspective view of a controller card.

FIG. 7 is a perspective view of the controller card of FIG. 6.

FIG. 8 is a front view of the controller card of FIG. 6.

FIG. 9 is a perspective view of a circuit board.

FIG. 10 is a top view of the circuit board of FIG. 9.

FIG. 11 is a diagram of a communication wiring diagram.

FIG. 12 is a diagram of a zone termination wiring diagram.

FIG. 13 is a flowchart of a card addressing process.

FIG. 14 is a flowchart of a parameter propagation process.

FIG. 15 is a flowchart of a failure detection process.

FIG. 16 is a flowchart of a settings transfer process.

FIG. 17 is a flowchart of a package tracking process.

FIG. 18 is a perspective view of another embodiment of a user interface.

FIG. 19 is a perspective view of another embodiment of a testing interface.

FIG. 20 is a block diagram of a conveyor system according to another example.

FIG. 21 is a screen rendering of a user interface that can be used in the FIG. 20 system.

FIG. 22 is a block diagram of a system for providing unsolicited feedback from the controller cards in the FIG. 20 system.

FIG. 23 is a screen rendering of a log screen.

FIG. 24 is a flowchart illustrating a technique for providing the unsolicited feedback.

FIG. 25 is a block diagram of a conveyor system according to a further example.

FIG. 26 is a flowchart depicting a technique for initiating a follow-me mode in the FIG. 25 system.

FIG. 27 is a flowchart depicting a technique for operating motorized drive rollers when in the follow-me mode.

FIG. 28 is a front view of a user interface of the controller card during initiation of the follow-me mode.

FIG. 29 is a front view of the user interface of the controller card during initiation of a zero-index mode.

FIG. 30 is a screen rendering of a user interface for initiating a global programming mode.

FIG. 31 is a diagram depicting a process for performing global programming in a serial manner.

FIG. 32 is a diagram depicting a process for performing global programming in a parallel manner.

FIG. 33 is a screen rendering of a user interface for performing a factory reset of the controller cards.

FIG. 34 is a flowchart depicting a technique for jammed zone self-recovery.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

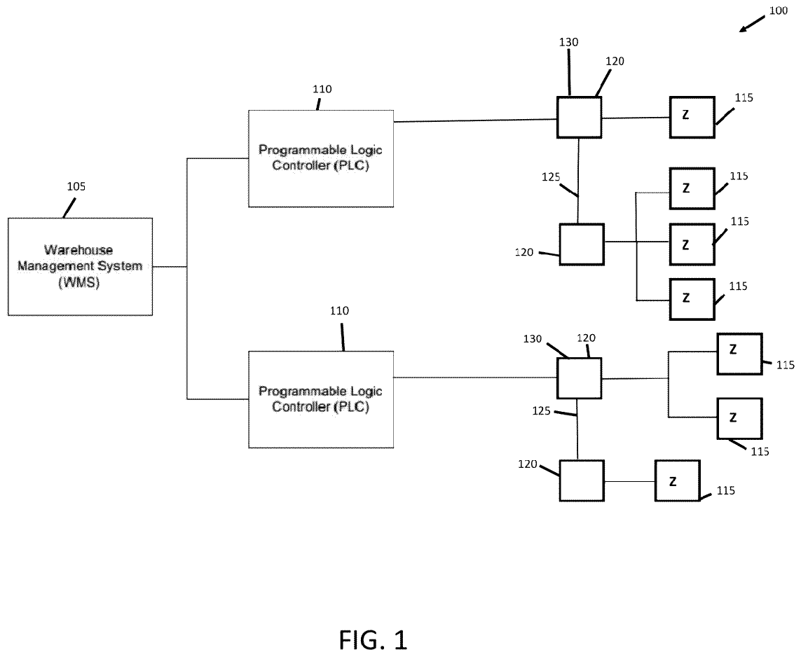

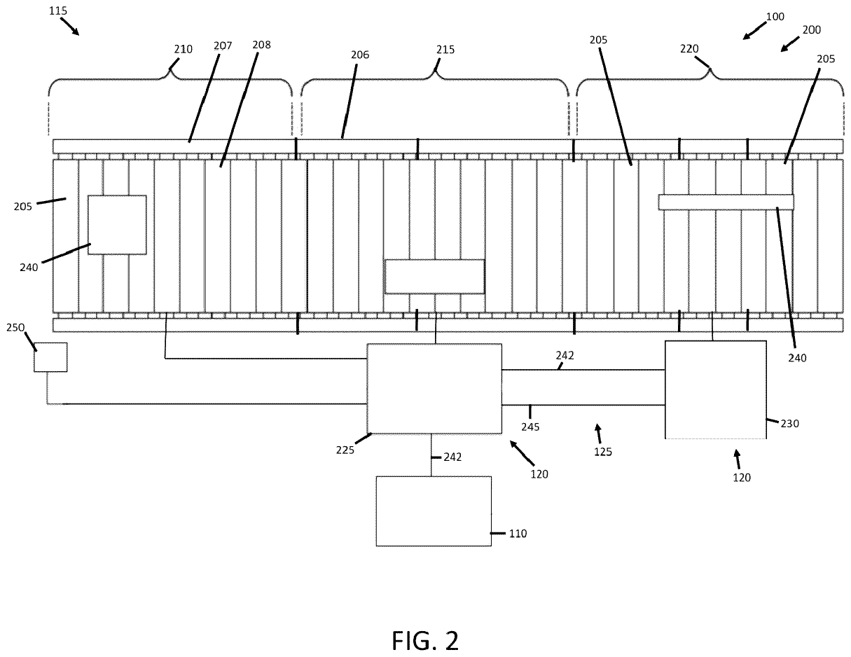

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

One example of a conveyor system 100 that addresses the above-mentioned issues as well as other issues is illustrated in FIG. 1. As shown, the conveyor system 100 includes a warehouse management system (WMS) 105 for monitoring and/or controlling the flow of packages or other items within a facility such as a warehouse or manufacturing plant. The conveyor system 100 further includes one or more programmable logic controllers (PLCs) 110 operatively connected to the warehouse management system 105 such as via a wired and/or wireless connection. In other embodiments, the programmable logic controllers 110 may be replaced with a robot management system. The robot management system is constructed to take over operation of the conveyor system 100 from the programmable logic controllers 110. Each programmable logic controller 110 is configured to monitor and/or control the operation of conveyor equipment within one or more conveyor zones 115. In the illustrated example, the conveyor zones 115 each have a controller card 120 configured to control and/or monitor the operation of conveyor equipment within their respective conveyor zones 115.

The controller cards 120 are daisy-chained together through a physical, wired connection in one example. As can be seen in some configurations, each of the controller cards 120 that are daisy-chained together are able to control one or more conveyor zones 115. In one example, each controller card 120 controls a single conveyor zone 115, but in other examples, a single controller card 120 may control two or more conveyor zones 115. As can seen in the illustrated example, a combination approach is used where some of the controller cards 120 control a single conveyor zone 115 and other controller cards 120 control multiple conveyor zones 115. The controller cards 120 in other configurations shown in FIG. 1 are daisy-chained across multiple conveyor zones 115. In the illustrated example, the controller cards 120 are operatively connected in a serial manner via one or more communication cables 125. In one variation, the communication cable 125 is in the form of an Ethernet type cable. As should be appreciated, an Ethernet cable commonly (but not always) is in the form of a cable containing twisted pairs of wires, such as a category 5 or 6 cable, with 8 position 8 contact (8P8C) modular connectors usually at both ends that are commonly referred to as registered jack 45 (RJ45) connectors. The RJ45 connectors are typically, but not always, plugged into a corresponding RJ45 plug to facilitate communication between the connected devices.

Together, the controller cards 120 form a controller area network (CAN) or local area network (LAN). In addition to the standard CAN communication protocol, the controller cards 120 further communicate amongst themselves using a sideband communication protocol that is outside the realm of the standard CAN communication protocol. The sideband communication protocol allows the controller cards 120 to communicate with each other without interfering with normal network communications which in turn provides additional capabilities.

In some types of communication standards, the full capacity of the physical communication channel is not used. For example, with the 10BASE-T or 100BASE-TX protocols, an Ethernet cable with the TS568A or T568B connector wiring assignments, only connector pins 1, 2, 3, and 6 (e.g., striped white/green, solid green, white/orange, and solid orange wires) of the RJ45 connector are generally used for communications. On the other hand, pins 4 and 5 (i.e., solid blue and striped white/blue wires) as well as pins 7 and 8 (striped white/brown and solid brown wires) are generally not used to communicate data.

The controller cards 120 use this untapped or unused channel capacity in the Ethernet cable to form a sideband communication channel or network that allows the controller cards 120 to communicate with one another along the chain of controller cards 120. In one version, one or more of the unused twisted pair wires or pins (e.g., pins 4 and 5) within an Ethernet cable form a sideband communication channel that facilitates sideband communication between the controller cards 120 using a serial communication protocol such as via universal asynchronous receiver-transmitter (UART) hardware. In one particular example, the communication cables 125 are in the form of Ethernet cables in which pins 4 and 5 of the RJ45 connectors are used to communicate using the RS-485 standard for robust serial communications. In other variations, pins 7 and 8 are alternatively or additionally used for the sideband communication between the controller cards 120 via the RS-485 standard. The RS-485 communication standard is especially helpful for sideband communications in the conveyor system 100 because the conveyor system 100 is typically used in electrically noisy environments like warehouses and manufacturing plants. The communications on this sideband communication channel do not interfere with the normal Ethernet communications between the conveyor zones 115 and controller cards 120 on the other wires within the communication cable 125 (e.g., RJ45 connector pins 1, 2, 3, and 6).

It should be recognized that this sideband communication technique can be used with other types of communication cables 125 so long as channel space is available for sideband communications. For example, while 8P8C modular connectors and paired wires were described above, it should be recognized that the sideband communication technique can be used in different designs that have more or less wires/pins. For instance, the sideband can be used in communication cables 125 that have 6 pin 6 connector (6P6C) type modular connectors (e.g., RJ11, RJ14, or RJ25 connectors) or 10 pin 10 connector (10P10C) type modular connectors (e.g., RJ50 connectors). Other examples of the communication cables 125 do not require twisted or untwisted wire pairs. For instance, the communication cable 125 can include a coaxial cable or fiber optic cable, and the unused communication channel space on the coaxial or fiber optic cable is used for sideband communications between the controller cards 120. In other variations, a wireless communication network (e.g., Wi-Fi) is used for communications between the controller cards 120, and some or all of the unused spectrum or channels is used to form a sideband communication network between the controller card 120.

Again, as can be seen in FIG. 1, the controller cards 120 are daisy-chained together with the communication cables 125. At the end of this chain, proximal to the programmable logic controller 110, the controller card 120 at this position is designated a chain master or leader card 130 (or gateway) through which communications to and from the programmable logic controller 110 and the controller cards 120 within the conveyor zone 115 are funneled.

The programmable logic controllers 110 through the CAN are further adapted to remotely configure or reconfigure the controller card 120. For instance, each controller card 120 in one version has inputs and outputs that are reconfigurable. The programmable logic controller 110 in one form is able to reprogram or override the default settings of the inputs and/or outputs of the controller card 120. The programmable logic controllers 110 in one variation reprogram the controller card 120 to send a notification over the CAN to the programmable logic controllers 110 when one or more conditions occur. For example, the controller card 120 can be programmed to send a notification when a conveyor zone 115 is empty and/or when an attached photoeye senses the presence or absence of an object. The programmable logic controllers 110 in one form treat the input/output of the controller card 120 as a gate. In other words, the programmable logic controller 110 is able to reconfigure the controller card 120 so that the card is able to act as a remote sensor without the need for installing a separate output extender.

One example of a conveyor system 200 that is used with the conveyor system 100 is depicted in FIG. 2. As shown, the conveyor system 200 includes one or more conveyors 205 organized into various conveyor zones 115. In the illustrated example, the conveyor 205 is a roller type conveyor, but it should be recognized that the conveyor 205 can include other types of conveyors like belt conveyors and slat conveyors. As depicted, each conveyor 205 includes a frame 206 with opposing rails 207 that support rollers 208 and are configured to convey or otherwise transport various packages or other items. The rollers 208 of the conveyor 205 for instance can include powered rollers, unpowered rollers, or any combination thereof.

The conveyors 205 are organized into the various conveyor zones 115. In the depicted example, the conveyor zones 115 include a first zone 210, a second zone 215, and a third zone 220, but it should be recognized that other configurations of the conveyor system 100 can include more or less conveyor zones 115. Each conveyor zone 115 can include one or more of the conveyors 205. Some or all of the conveyor zones 115 can include a single conveyor 205 in certain configurations, and the conveyor zones 115 in other configurations can have multiple conveyors 205.

As noted above with respect to FIG. 1, the controller cards 120 in the conveyor zones 115 are daisy-chained together via the individual communication cables 125. The daisy-chained controller cards 120 can control a single conveyor zone 115 or can control multiple conveyor zones 115. The controller card 120 in the chain connected to the programmable logic controller 110 is once more the leader card 130 for the chain of controller cards 120. The leader card 130 typically, but not always, is connected to the programmable logic controller 110 using the same type of communication cable 125 connecting the controller cards 120 together. For instance, the leader card 130 in one form is connected to the programmable logic controller 110 via an Ethernet cable. In one variation, the sideband communication along the communication cable 125 is limited to communications between the controller cards 120, and the controller cards 120 do not communicate with the programmable logic controller 110 via the sideband communication link. In other variations, the controller cards 120 can communicate with the programmable logic controller 110 via a sideband communication link.

The controller cards 120 are operatively connected to the conveyors 205, sensors, equipment, and/or other devices within the corresponding conveyor zone 115. In turn, the controller cards 120 are able to monitor the operation of and control the conveyors 205 within the particular conveyor zone 115. For instance, the conveyor zone 115 can be used to instruct one or more rollers 208 within the conveyor zone 115 to move or stop. For explanation purposes, the controller card 120 controlling a particular conveyor zone 115 may be identified by the zone number. For example, the controller card 120 controlling the first zone 210 may be referred to as a first controller card 225, and the controller card 120 controlling the third zone 220 may be referred to as a third controller card 230. With the controller cards 120, the warehouse management system 105 and/or programmable logic controller 110 is able to monitor and control movement of one or more packages 240 or other items on the conveyors 205 in the various conveyor zones 115.

As mentioned previously, the controller cards 120 are typically connected via the communication cables 125, and the communication cable 125 has a main/primary CAN communication link or main communication channel 242 and a sideband communication channel 245. The sideband communication channel 245 enables the controller cards 120 to exchange information relating to status, package location, and/or other pertinent data without interrupting communications along the main communication channel 242. In one example, the communication cables 125 are in the form of Ethernet cables using the TS568A (or T568B) connector wiring (pin) assignments. In this example, the main communication channel 242 uses the 10BASE-T or 100BASE-TX protocols such that connector pins 1, 2, 3, and 6 of the RJ45 connector along with the corresponding wires form the main communication channel 242. The warehouse management system 105 and/or programmable logic controller 110 communicate with the controller cards 120 using the 10BASE-T or 100BASE-TX protocols along this primary, main communication channel 242. In this example, pins 4 and 5 of the RJ45 connector and the corresponding wires in the communication cable 125 form the sideband communication channel 245 along which the controller cards 120 are able to communicate with each other using the RS485 serial communication protocol.

Once more, it should be recognized that other types of communication protocol can form the main communication channel 242 and sideband communication channel 245. For instance, when a wireless communication network is used for communications between the controller cards 120, the carrier can be used for the main communication channel 242, and the upper sideband (USB) and/or lower sideband (LSB) can be used for the sideband communication channel 245.

Other types of devices or sensors besides the conveyor 205 can be operatively connected to the controller cards 120. In the illustrated example of FIG. 2, the conveyor system 200 has a photoeye 250 that is operatively connected to one of the controller cards 120. The photoeye 250 detects the presence of the package 240 in a particular conveyor zone 115. The photoeye 250 then shares the package 240 information with the controller card 120 within the proper conveyor zone 115. To track the progress of the package 240, the first controller card 225, which controls the first zone 210 and the second zone 215, transmits a package identifier via the sideband communication channel 245 to the third controller card 230 as the package 240 moves from the second zone 215 to the third zone 220. This process continues downstream until reaching the end of the conveyor system 200.

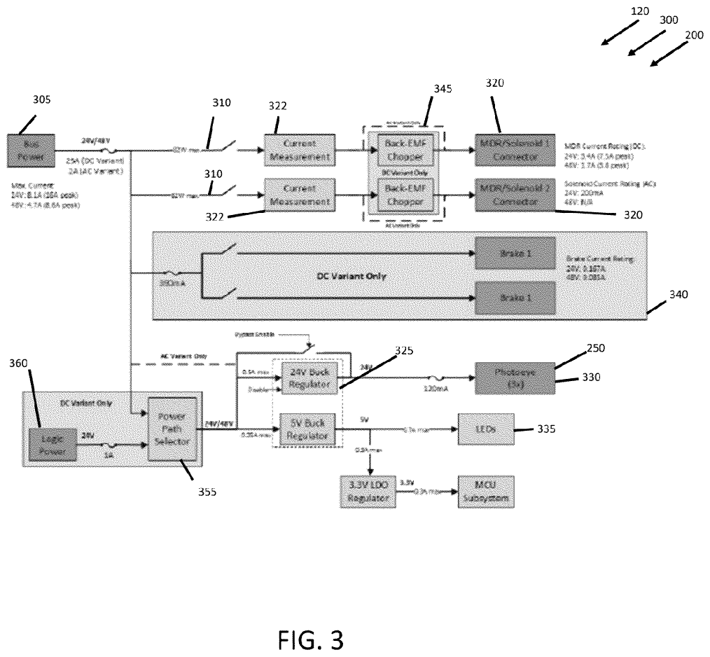

As shown in FIG. 3, each controller card 120 of the conveyor system 200 includes a power system 300 for supplying and controlling power to the controller card 120 as well as other equipment such as the conveyor 205 and the rollers 208. The power system 300 includes bus power 305. In some examples, the bus power 305 is 24 volts (V). However, in other examples the bus power 305 is 48V. The bus power 305 flows through a series of parallel paths where power flow is controlled via a number of switches 310. The switches 310 typically function in an open/closed manner where an open switch does not allow power flow and a closed switch does allow power flow.

In an alternating current (AC) system the power continues to flow into a conveyor power connector 320 that for example supplies power to an electrically powered component of the conveyor 205. For instance, the conveyor power connector 320 may power a motorized drive roller (MDR), a solenoid, and/or another device requiring AC power to operate. The AC power may also flow to one or more photoeyes 250. Current drawn to power the components connected to the conveyor power connector 320 is measured via one or more current sensors 322.

In a direct current (DC) system the power is changed from fixed DC to variable DC power. Typically, this is done via a chopper 345 integrated into the system upstream of the conveyor power connector 320. A brake 340 is also included in the DC system. The DC system may also include logic power 350 configured to power the control logic of the conveyor system 200. The logic power 350 may also run into a power path selector 355, which sends the DC power through one or more regulators 325. From the regulators 325 power may flow into one or more photoeyes 330 and/or one or more light emitting diodes 335.

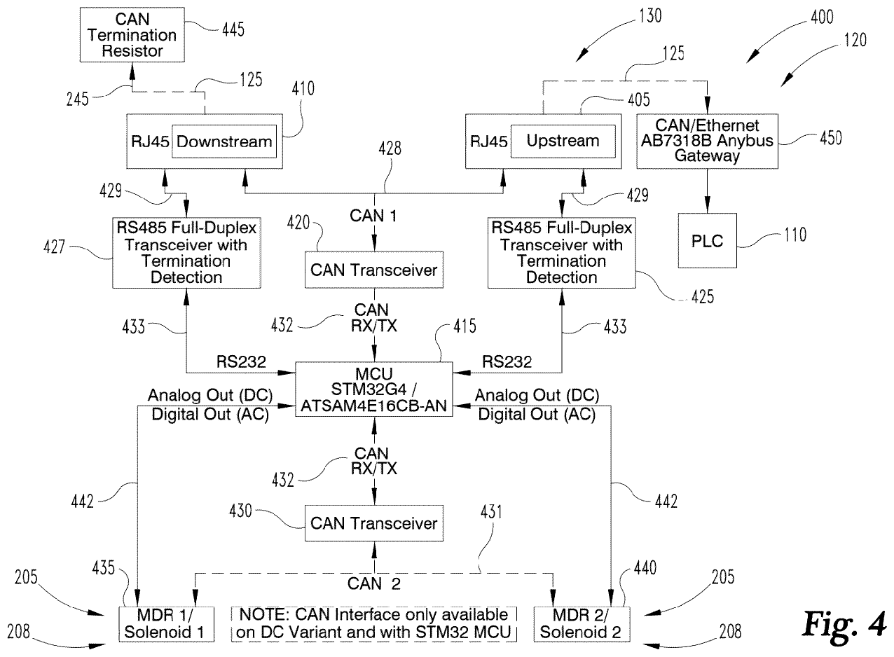

Turning to FIG. 4, an example of a communication system 400 for the controller card 120 is shown. The communication system 400 includes an upstream port 405 and a downstream port 410. Generally, the upstream port 405 of a controller card 120 is connected to the downstream port 410 of a preceding controller card 120 or the programmable logic controller 110. Likewise, the downstream port 410 is connected to the upstream port 405 of following controller cards 120 or to generally nothing. In one example, the upstream port 405 and downstream port 410 are in the form of RJ45 type sockets configured to receive corresponding connector plugs of the communication cable 125 in the form of an Ethernet cable. The connections at the upstream port 405 and downstream port 410 can be configured differently in further variations. In still yet other examples, the connections may be wireless.

The upstream port 405 and downstream port 410 communicate with a motor control unit 415 via a first network carrier transceiver 420 along with an upstream sideband transceiver 425 and a downstream sideband transceiver 427. In the illustrated example, the first network carrier transceiver 420 is in the form of a controller area network (CAN) transceiver that transmits and receives communications from the programmable logic controllers 110 and other controller cards 120 along the main communication channel 242 of the communication cable 125. As shown, the first network carrier transceiver 420 is operatively connected to the upstream port 405 and downstream port 410 via the first carrier network connection 428. The upstream sideband transceiver 425 and downstream sideband transceiver 427 are operatively connected to the upstream port 405 and downstream port 410, respectively, via one or more sideband connections 429. The upstream sideband transceiver 425 receives and transmits sideband communications from controller cards 120 located upstream from the current controller card 120 via the upstream port 405, and the downstream sideband transceiver 427 receives and transmits sideband communications from controller cards 120 located downstream from the current controller card 120. As should be appreciated, the sideband communications via the upstream sideband transceiver 425 and downstream sideband transceiver 427 can generally occur without interfering with normal communications via the first network carrier transceiver 420.

Returning to the previously described Ethernet example where the communication cables 125 are in the form of Ethernet cables using the TS568A (or T568B) connector pin assignments, the main communication channel 242 uses the 10BASE-T or 100BASE-TX protocols such that connector pins 1, 2, 3, and 6 of the RJ45 connector along with the corresponding wires form the main communication channel 242. Via pins 1, 2, 3, and 6 of the upstream port 405 and/or the downstream port 410, the first network carrier transceiver 420 communicates with the programmable logic controller 110 and/or other controller cards 120 using the Ethernet protocols along the primary, main communication channel 242 of the communication cable 125. In this same example, pins 4 and 5 of the RJ45 connector and the corresponding wires in the communication cable 125 form the sideband communication channel 245 along which the controller cards 120 are able to communicate with each other using the RS485 serial communication protocol.

As depicted, the motor control unit 415 is operatively connected to the first network carrier transceiver 420, upstream sideband transceiver 425, and downstream sideband transceiver 427 so as to be able to communicate along the main communication channels 242 and sideband communication channels 245 of the communication cables 125. The motor control unit 415 is further operatively connected to other components in the corresponding conveyor zone 115. For instance, the motor control unit 415 is operatively connected to a second network carrier transceiver 430 that communicates with components of the conveyor zone 115 (e.g., the conveyor 205, photoeye 250, etc.) through a conveyor or second carrier network 431. Both the first network carrier transceiver 420 and second network carrier transceiver 430 are operatively connected to the motor control unit 415 through motor control unit carrier links 432. The upstream sideband transceiver 425 and downstream sideband transceiver 427 are operatively connected to the motor control unit 415 via one or more motor control unit sideband links 433.

With continued reference to FIG. 4, the motor control unit 415 via the second carrier network 431 is operatively connected to a first electrical device 435 and a second electrical device 440. Alternatively or additionally, the motor control unit 415 is directly connected to the first electrical device 435 and second electrical device 440 via one or more direct conveyor connections 442. The direct conveyor connections 442 can include digital or analog type connections. The first electrical device 435 and second electrical device 440 can include rollers 208 in the form of motorized drive rollers (MDRs), solenoids, or other equipment and/or sensors (e.g., photoeyes 250) associated with the conveyors 205. Through the second network carrier transceiver 430 and/or direct conveyor connection 442, the motor control unit 415 is able to monitor and control the rollers 208. For instance, the motor control unit sideband link 433 is able to power and control the speed and operation of MDRs in the conveyors 205 as packages 240 are transported on the conveyors 205. Information from the conveyors 205 as well as sensors associated with the conveyors 205 is processed via the motor control unit 415 and communicated to the programmable logic controllers 110 and/or controller cards 120 via the main communication channels 242 and/or sideband communication channels 245. For instance, the motor control unit 415 can be used to track packages 240 as the packages 240 travel on and between various conveyor zones 115.

Through the upstream sideband transceiver 425, the controller card 120 is able to determine the relative chain location of the controller card 120 along a given daisy-chained set of controller cards 120. The sideband communication capability facilitates in determining whether the controller card 120 is the first controller card 120 in the chain, the last controller card 120 in the chain, or somewhere in the middle.

Looking at FIG. 4, a termination resistor 445 in one example is connected to the downstream port 410 when the controller card 120 is the last one in the chain. By measuring the resistance (or voltage) of the termination resistor 445 (or the sideband communication channel 245 at the downstream port 410), the motor control unit 415 of the controller card 120 is able to determine that the controller card 120 is the last one in the chain. For instance, the termination resistor 445 can have a high resistance which indicates that no downstream controller card 120 is connected to the downstream port 410. On the other hand, when the resistance is within a range that indicates a downstream controller card 120 is connected, then the controller card 120 determines the controller card 120 is not the last one. Alternatively or additionally, when nothing is connected to the sideband communication channel 245 at the downstream port 410 (i.e., open contact), the open signal or very high resistance signifies that no downstream controller card 120 is connected, and the current controller card 120 is the last one in the chain. Returning to the previous Ethernet example, when a high resistance or an open condition is detected at pins 5 and 6 of the RJ45 socket at the downstream port 410, the controller card 120 determines the controller card 120 is the last one in the chain. Alternatively or additionally, the downstream sideband transceiver 427 can broadcast a ping or request a response via the downstream port 410 on the sideband communication channel 245. If no response is received, the controller card 120 is the last one on the chain. Conversely, if a response is received, then the controller card 120 is not the last one in the chain.

In certain cases, the programmable logic controllers 110 of the controller card 120 are directly connected to the upstream port 405 via one of the communication cables 125. Sometimes however, as is shown in FIG. 4, the leader card 130 is indirectly connected to the programmable logic controller 110 through a CAN gateway 450. In either case, the controller card 120 can determine if the controller card 120 is the first one in the chain, or the leader card 130, by communicating via the upstream port 405. For instance, the first network carrier transceiver 420 of the controller card 120 can ping or request a response from the programmable logic controller 110 by communicating over the main communication channel 242 via the upstream port 405. If a response from the programmable logic controller 110 is received, the controller card 120 is the leader card 130. Conversely, when no response is received from the programmable logic controller 110, the controller card 120 is not the first one in the chain. Alternatively or additionally, the upstream sideband transceiver 425 can send a signal (or measure resistance like before) along the sideband communication channel 245 to determine whether another controller card 120 is located upstream. If the signal or measured resistance (or voltage) is indicative of no connection, the controller card 120 infers the controller card 120 is the leader card 130.

The controller card 120 is also configured to determine when the controller card 120 is not installed or not properly installed. For example, using the techniques described above, when the controller card 120 detects that the controller card 120 is not connected at the upstream port 405 and downstream port 410, then the controller card 120 is considered uninstalled or not connected.

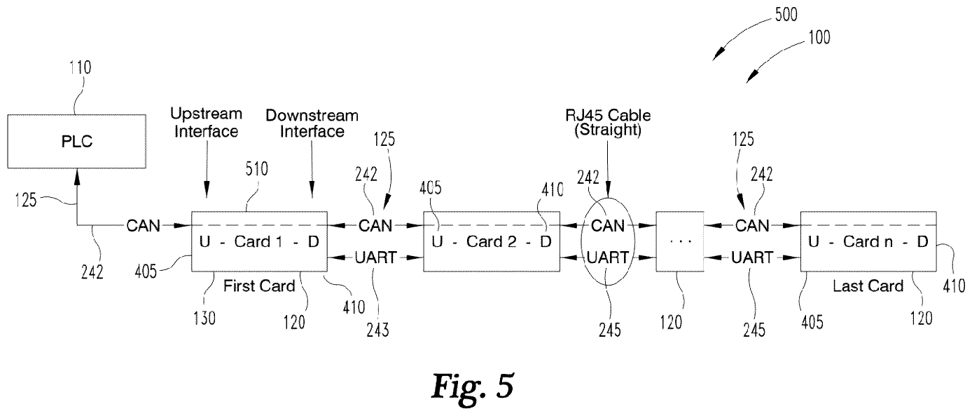

One example of a sideband communication system 500 that can be incorporated into the conveyor system 100 is illustrated in FIG. 5. As mentioned previously, the controller card 120 communicates via the sideband communication system 500. The controller cards 120 include a first controller card 510 and a second controller card 520. The first controller card 510 and second controller card 520 are once more operatively connected via the communication cable 125. As noted before, the communication cable 125 includes the main communication channel 242 and the sideband communication channel 245. In the illustrated example, the main communication channel 242 facilitates communication via a controller area network (CAN) type protocol, and the sideband communication channel 245 facilitates communication using a universal asynchronous receiver-transmitter (UART) type protocol.

In this example, the first controller card 510 acts as the leader card 130. The programmable logic controller 110 is operatively connected to the upstream port 405 of the first controller card 510 via the communication cable 125. The first controller card 510 receives a command from the programmable logic controllers 110 via the main communication channel 242 of the communication cable 125. Through the communication cable 125, the downstream port 410 of the first controller card 510 is connected to the upstream port 405 of the second controller card 520. The first controller card 510 passes the command to the next (downstream) second controller card 520 through the communication cable 125. Subsequent downstream controller cards 120 are connected in a similar fashion and communicate in a similar fashion. In one form, the connection of the downstream port 410 of the first controller card 510 to the upstream port 405 of the second controller card 520 is via a RJ45 type ethernet cable. Once more, other types of connections can be used in other examples.

The sideband communication system 500 of the conveyor system 100 is configured to allow the controller cards 120 to automatically self-identify such as during initial installation, replacement, and/or general maintenance. The status or identity of the controller card 120 can be determined in a number of ways. As explained above, the controller card 120 can determine the relative location of the controller card 120 in the chain of controller cards 120 in several ways. Based on this determination of relative location, the controller card 120 can initiate the self-addressing or identification process. For example, if the controller card 120 does not sense a connection or signal on the sideband communication channel 245 at the upstream port 405 of the controller card 120 where the communication cable 125 for an upstream controller card 120 is normally connected, the controller card 120 can self-identify as being the first card in the daisy-chain (e.g., the leader card 130). In an alternative or additional variation, the leader card 130 or first controller card 510 self-identifies by detecting the programmable logic controllers 110 being directly connected to the upstream port 405 of the first controller card 510.

In one version, the leader card 130 self-identifies by self-assigning a specific address or other identifier (e.g., 1), and the remaining controller cards 120 in the chain can increment their addresses relative to the address of the leader card 130 (e.g., 2, 3, etc.). The leader card 130 in other examples can self-identify when a specific sensor, such as a wake-up photoeye 250, is connected to the card. Once the leader card 130 has been identified, the remaining downstream cards are again able to self-identify in a sequential or cascading fashion from the first card (e.g., 2, 3, 4, etc.). For example, the second controller card 520 in one form receives a signal, such as in the form of an address, identifier, and/or command, through the sideband communication channel 245 from the upstream, first controller card 510. In response to receiving the signal, the immediate downstream card self-identifies as the second controller card 520 (e.g., 2), and using the sideband communication channel 245 connected to the downstream port 410 of the second controller card 520, the newly self-identified second controller card 520 communicates with the next downstream controller card 120 so that the third card can self-address or identify in a similar fashion. This process of self-identifying continues in a similar fashion of the remaining controller cards 120 until the last controller card 120 is reached. Each time an address is assigned, the address and other pertinent information can be broadcasted to the other controller cards 120 in the link through the sideband communication network.

As explained above, the last controller card 120 can self-detect its relative position in the chain in several ways. For instance, the last controller card 120 can detect a high resistance or open connection on the sideband link pins in the downstream port 410. The last controller card 120 in the line can also self-identify as being the last controller card 120 in the line by monitoring signals from other connected devices like sensors and/or motors. Once the last controller card 120 is assigned an address, the last controller card 120 can communicate the completion of the process on the sideband communication network. It should be recognized that this technique of self-addressing the controller cards 120 reduces the risk of address errors as well as simplifies installation of new controller cards 120. Moreover, using the sideband communication network (i.e., the sideband communication channels 245) with this technique, reduces congestion on the carrier network or CAN as well as reduces communication errors.

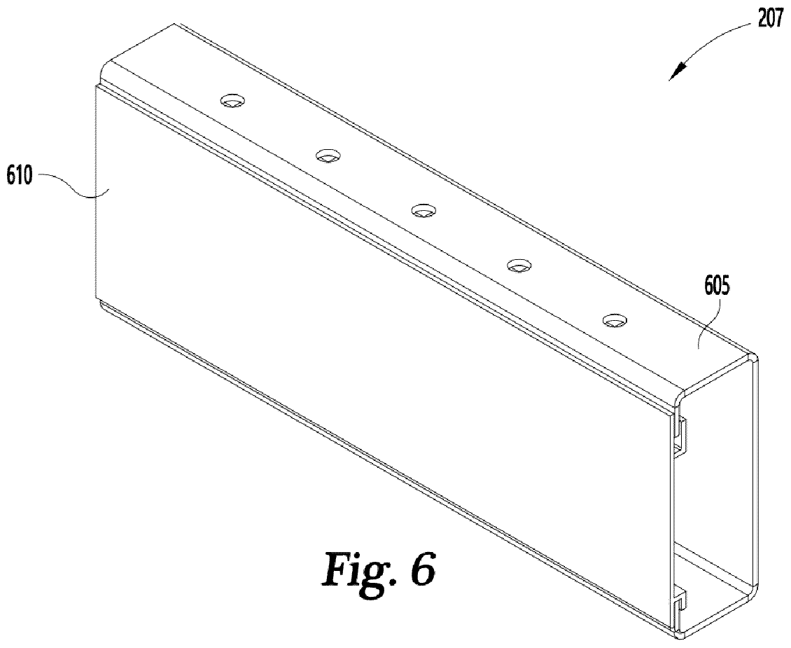

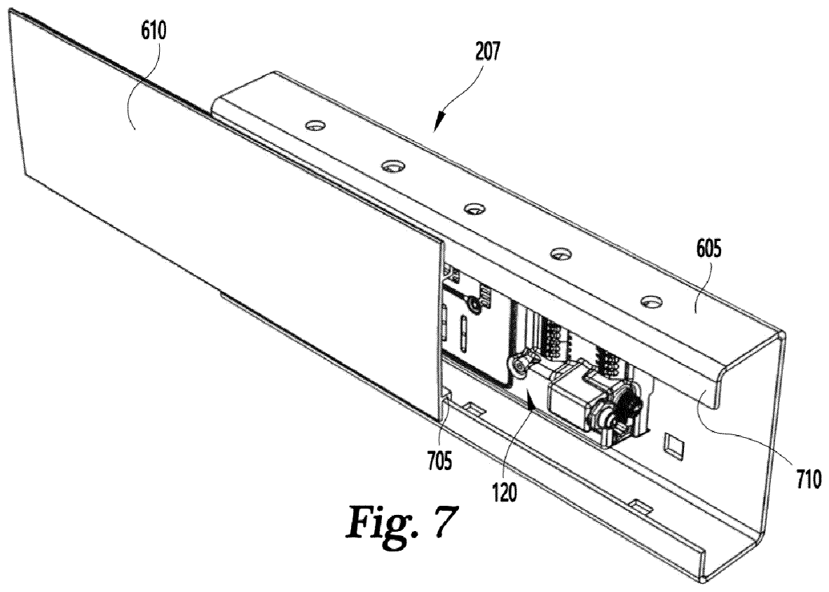

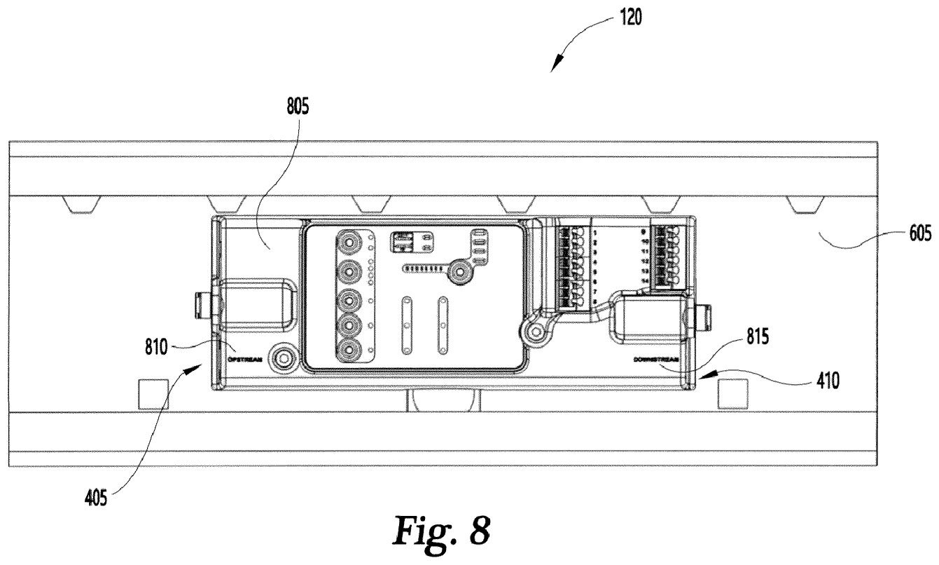

Shown in FIGS. 6, 7, and 8, is an example of the controller card 120 described previously. The controller card 120 is typically retained within a channel 605 of the rails 207. The controller card 120 may be located behind an access panel 610 to prevent damage to the controller card 120. The access panel 610 is slidably removable from the channel 605 via groove 705. The groove 705 slides on a set of tracks 710 extending from the channel 605. The channel 605 is configured to surround and protect a circuit board 805, an upstream port 810, and a downstream port 815. As should be appreciated, the upstream port 810 corresponds to the upstream port 405 and the downstream port 815 corresponds to the downstream port 410 described in the previous examples.

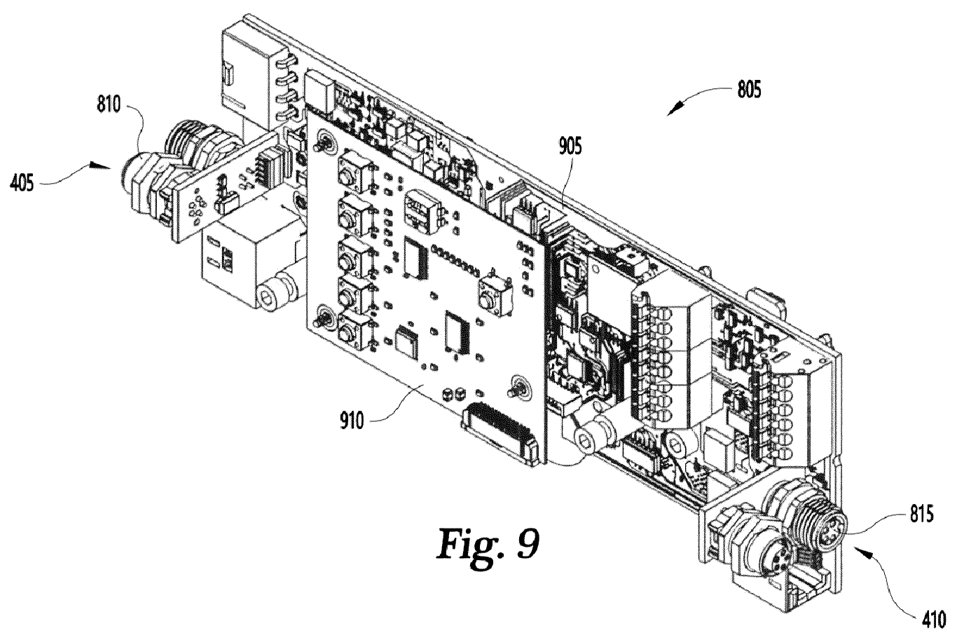

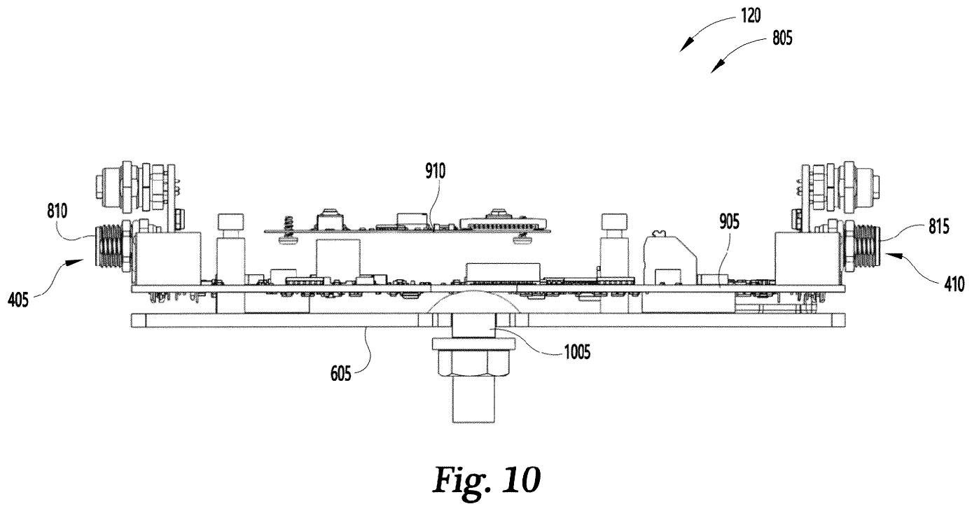

As shown in FIGS. 9 and 10, the circuit board 805 includes a main board 905 and a secondary board 910. The controller card 120 is mounted to a desired work location via a fastener 1005. The fastener 1005 may be a screw, bolt, rivet, weld, adhesive, and/or another type of fastener.

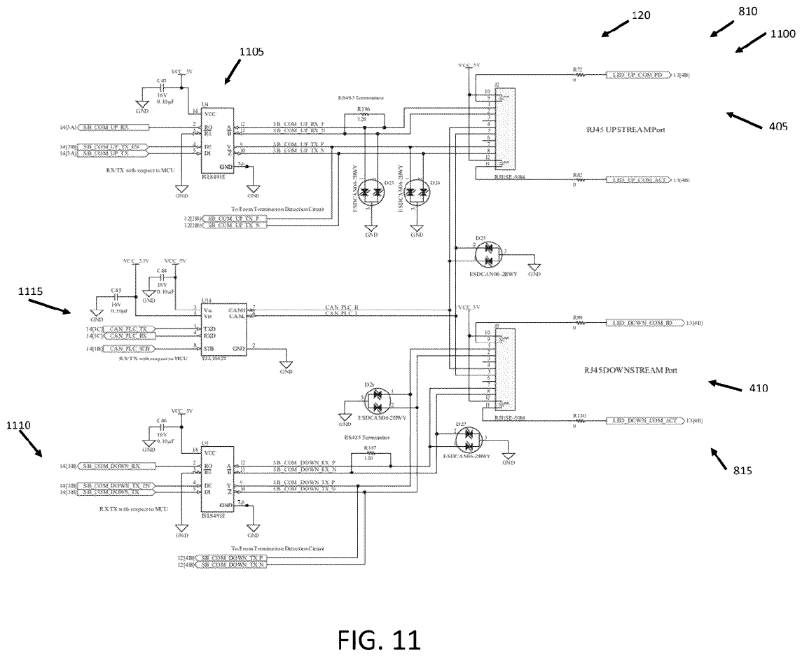

Illustrated in FIG. 11 is a communication wiring diagram 1100 for one version of the controller cards 120. The communication wiring diagram 1100 includes an upstream controller 1105, a downstream controller 1110, and a control area network (CAN) controller 1115. The upstream controller 1105 monitors the upstream port 810 described previously. For example, the upstream controller 1105 monitors the upstream port 810 to determine the controller card 120 position in a chain. The downstream controller 1110 monitors the downstream port 815 described previously. For example, the downstream controller 1110 monitors the upstream port 810 to determine the controller card 120 position in a chain. The control area network (CAN) controller 1115 monitors both the upstream port 810 and downstream port 815. If an error occurs the control area network (CAN) controller 1115 reports the error to a user.

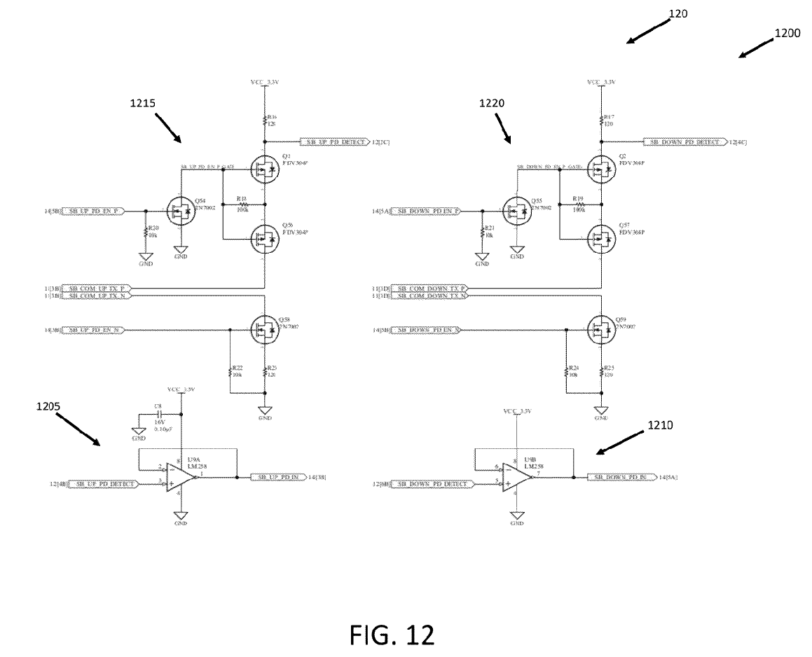

Illustrated in FIG. 12 is a zone termination wiring diagram 1200 for the controller card 120. The zone termination wiring diagram 1200 includes an upstream detection circuit 1205, a downstream detection circuit 1210, an upstream communication circuit 1215, and a downstream communication circuit 1220. The upstream detection circuit 1205 detects whether the upstream port 810 is receiving a signal. If not, the upstream detection circuit 1205 sends a signal to the upstream communication circuit 1215, which indicates that the controller card 120 is the first in a chain. The downstream detection circuit 1210 detects whether the downstream port 815 is a receiving a signal. If not, the downstream detection circuit 1210 sends a signal to the downstream communication circuit 1220, which indicates that the controller card 120 is the last in a chain.

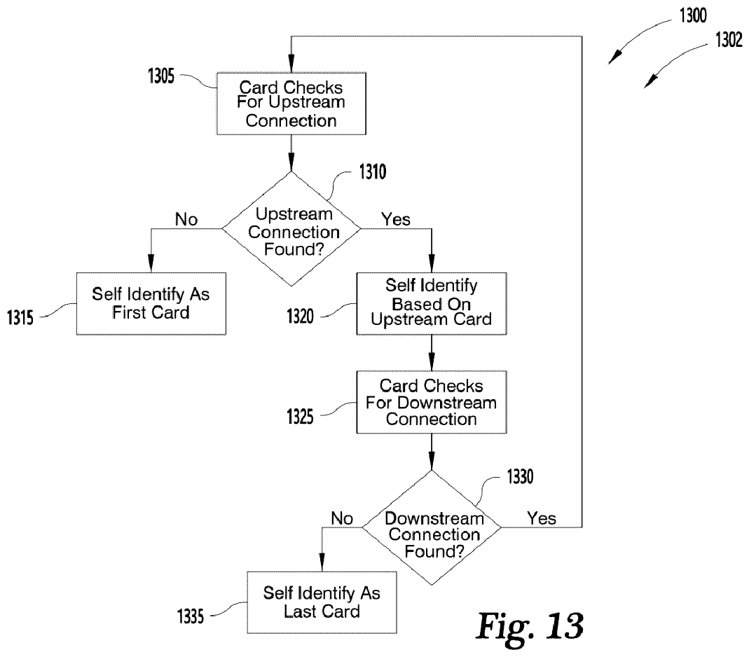

Shown in FIG. 13, is a flowchart 1300 of a card addressing process 1302. At stage 1305, the controller card 120 checks the upstream port 810 to determine if a signal is received. At stage 1310, if no signal is received, the controller card 120 identifies as the first, leader card 130 in the chain at stage 1315 with a card number of one (1), for example. If a signal is received, the controller card 120 self assigns a sequential number at stage 1320. For example, if the controller card 120 upstream of the target controller card 120 is number three (3), then the downstream target controller card 120 will self identify as controller card 120 number four (4) in the chain. At stage 1325, the controller card 120 checks the downstream port 815 to determine if a signal is received. At stage 1330, if no signal is received, the controller card 120 self identifies as the last or terminal card in the chain at stage 1335.

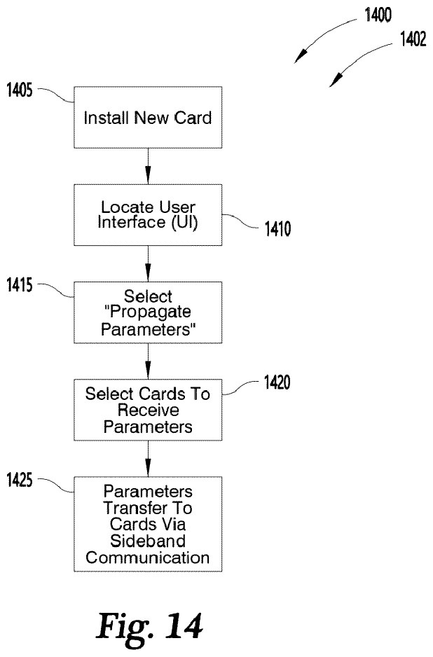

Looking at FIG. 14, a flowchart 1400 of a parameter propagation process 1402 is shown. At stage 1405, a new controller card 120 is installed in a conveyor zone 115. At stage 1410, the user locates a user interface (UI). The UI may be either on a remote electronic device and/or may be directly adjacent the controller card 120. In one example, the UI is on a remote computer. At stage 1415, the user selects a propagate parameters option within the UI. At stage 1420, the user selects the number of newly installed controller cards 120 to flash/upload the parameters to. At stage 1425, the parameters are uploaded to the controller card 120. In one example, the parameters include conveyor speed parameters. In another example, the parameters include MDR type and operation parameters.

During installation or maintenance of multiple controller cards 120, programming or setting the operational parameters for the individual cards can be a laborious process. The sideband communication system 500 is configured to facilitate this programming of multiple controller cards 120 at or nearly at the same time by propagating the settings of one card to the other cards. In one aspect, the sideband communication system 500 allows for the user interface (UI) to propagate operating parameters or settings to all of the cards through the sideband communication protocol almost instantaneously, or in some cases, in a sequential manner. In one form, the UI includes a series of buttons and light emitting diodes (LEDs), and in other forms, the UI includes a touchscreen or other types of UIs. In one example, a user selects a parameter and holds down a button on the selection for a few seconds before a selection window asks if the user wants to propagate the parameters to all connected controller cards 120. Via the sideband communication system 500, the controller card 120 transmits over the CAN the parameters to the other cards without having to program each separately.

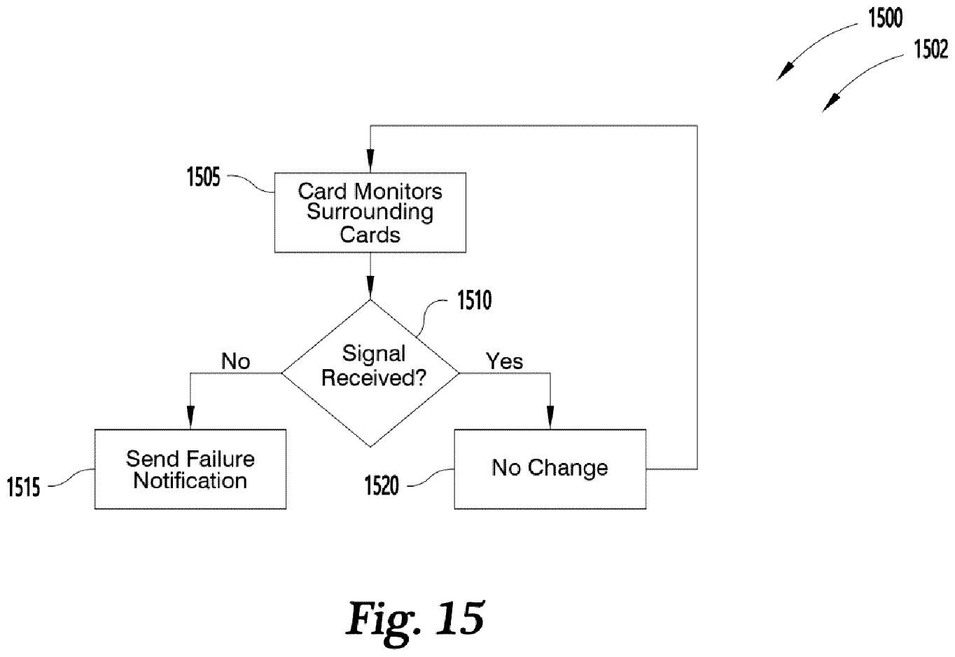

Illustrated in FIG. 15, is a flowchart 1500 showing a failure detection process 1502. At stage 1505, the controller card 120 monitors the surrounding controller cards 120 via a sideband communication system 500 via the upstream port 810 and downstream port 815. At stage 1510, if the card does not receive a signal, a failure notification is sent to a user at stage 1515. In some examples, the failure notification is an alert on a mobile device and/or computer. In another example, the alert is a visual or audible signal from the controller card 120. At stage 1510, if the card does receive a signal, there is no change and the process continues as normal at stage 1520.

The sideband communication system 500 further allows controller cards 120 to detect failures in neighboring cards. For example, when communication in a neighboring card is sporadic or even nonexistent, the controller card 120 in one variation sends a notification to the appropriate equipment (e.g., a PLC, computer, etc.) and/or personnel of the potential card failure. In other variations, the controller card 120 monitors signals and operating conditions of neighboring cards to determine their operational status. For instance, when an item is transferred from an upstream conveyor section controlled by an upstream card to a downstream conveyor section controlled by a downstream card and the downstream card does not signal receipt of the item back to the upstream card, either on a continuous or intermittent basis, the upstream card sends a notification of potential failure of the downstream card to the appropriate equipment and/or personnel.

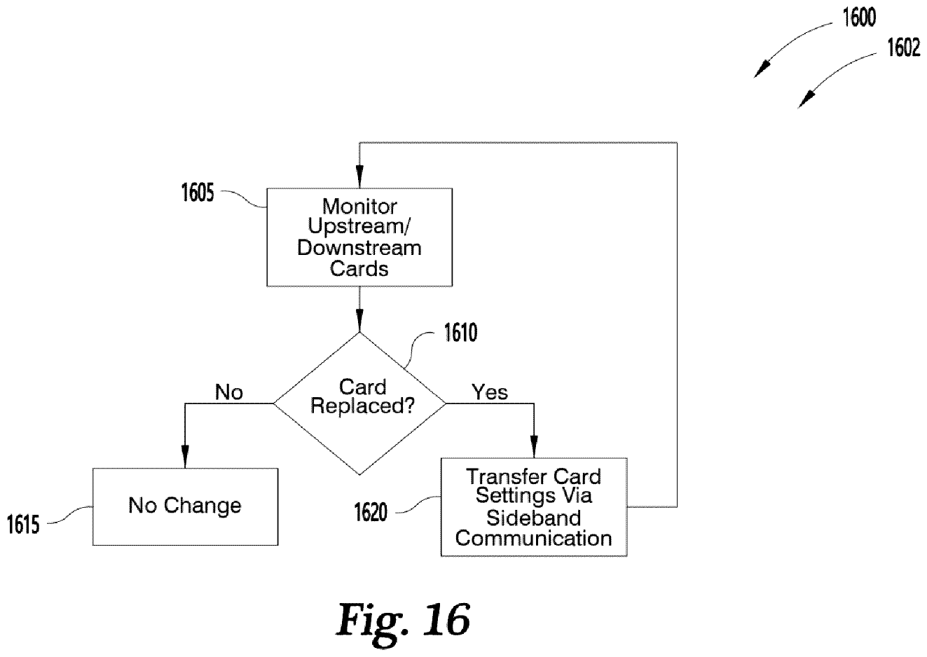

Depicted in FIG. 16 is a flowchart 1600 of a settings transfer process 1602. At stage 1605, the controller card 120 monitors the upstream and downstream controller cards 120 via the upstream port 810 and downstream port 815. At stage 1610, the controller card 120 determines whether an upstream or downstream card is replaced. At stage 1615, if no card was replaced, the controller card 120 continues operation as usual. At stage 1620, if an upstream or downstream card was replaced, the controller card 120 can transfer the previous upstream/downstream cards settings onto the new controller card 120 via sideband communication system 500. This is done via a memory system that retains the settings information of the controller cards 120 immediately upstream and downstream of the card. As should be appreciated, this system allows for the replacement of two adjacent controller cards 120 without manual reprogramming. For example, in a series of four (4) controller cards 120, the two middle controller cards 120 can be replaced and automatically programmed by the exterior or bookending controller cards 120. As should be appreciated, this process can be continued down the entire line of daisy-chain connected controller cards 120 to replace almost all of the controller cards 120 without the need for manual reprogramming.

The sideband communication system 500 facilitates an automatic recovery mode or buddy capability that allows controller cards 120 to be readily replaced in case of card failure or system maintenance. With this recovery capability, each card has memory for storing the settings of cards located immediately upstream and downstream from the card. The configuration information from the upstream and downstream cards in one example is communicated using the sideband communication system 500. When a failed controller card 120 is replaced with a new controller card 120, the upstream and/or downstream card automatically transfers the previous configuration settings to the new card using the sideband channel, thus saving time, effort, and money during card replacement. With each controller card 120 storing the settings for both the upstream and downstream cards, at least two intermediate control cards can be replaced and automatically programed by the upstream and downstream cards.

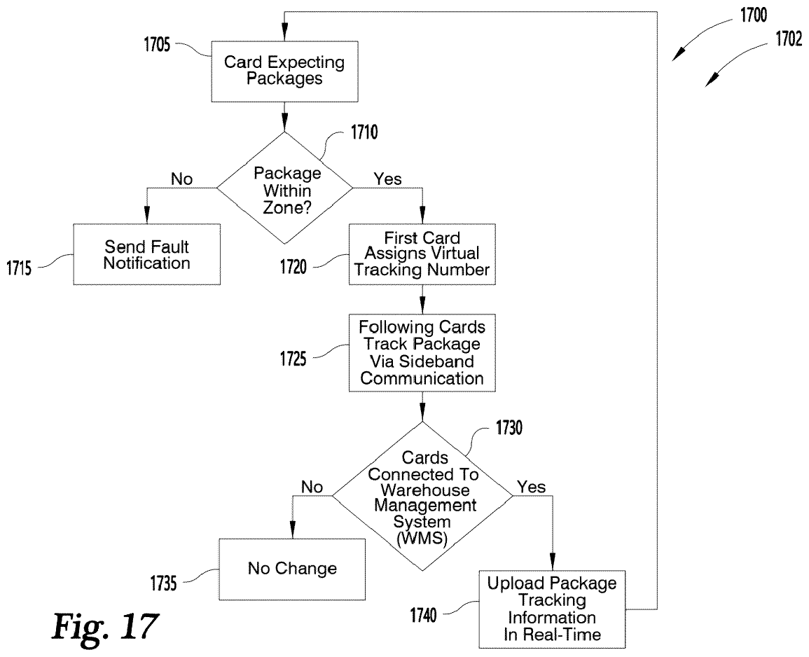

FIG. 17 shows a flowchart 1700 of a package tracking process 1702. At stage 1705 the controller card 120 is operational and expecting packages 240. At stage 1710, the controller card 120 detects whether a package 240 is within the conveyor zone 115. In one example, the controller card 120 detects a package 240 via a photoeye 250. The photoeye 250 sees the package 240 and transmits that information to the controller card 120. In another example, the controller card 120 detects the package 240 via electrical signal changes. For example, a change in current. If no package 240 is detected when expected, the controller card 120 sends a fault notification to a user indicating an error at stage 1715. If a package 240 is detected, the controller card 120 assigns a virtual tracking number associated with the package 240 at stage 1720. At stage 1725, the subsequent downstream cards continue to monitor the movement and position of the package 240 via transfer of the virtual tracking number through the sideband communication system 500. At stage 1730, the controller card 120 determines whether there is a connection to a warehouse management system 105. If not, the process continues as usual at stage 1735. If the controller card 120 is connected to a warehouse management system 105, the controller card 120 constantly uploads the package tracking information to the warehouse management system 105 for real-time tracking of packages 240 at stage 1740.

The sideband communication system 500 further allows scanner-less, zone-to-zone tracking of packages 240 or other items along various conveyor zones 115. The system in one form is configured to track packages 240 in the conveyor zones 115 by assigning virtual tracking numbers. Alternatively or additionally, the system receives a unique identifier for the package 240 from a barcode and/or radio frequency identification (RFID) scanner located along an upstream conveyor zone. Once identified, the package 240 can be tracked along various conveyor zones 115 without the need for rescanning because the controller card 120 through the sideband communication system 500 communicates the package identifiers when the packages 240 are moved along and/or transferred from the various conveyor zones 115.

For instance, when a package 240 is received on a conveyor zone 115 controlled by a card, the upstream card sends to the current conveyor section card the identifier for the package, and the current conveyor card stores the package identifier in memory. Based on the conveyor speed and information from sensors along the conveyor section as well as other factors, the controller card 120 determines and tracks the location of the package 240 on the conveyor zone 115. Through the CAN, the controller card 120 in one form transmits the package identifier (either virtual or actual identifier) as well as other information to the warehouse management system 105 or other system so that the package location is tracked throughout a facility. Before, during, or after the tracked package 240 leaves the conveyor zone 115 controlled by the controller card 120, the card transmits the package identifier to the downstream card so that the package can then be tracked along the downstream conveyor zone.

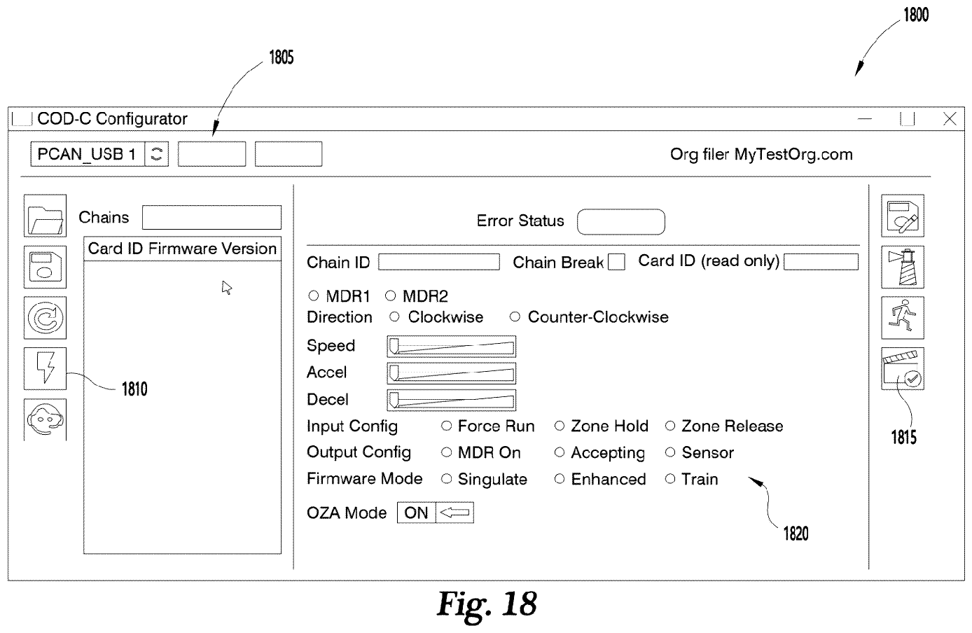

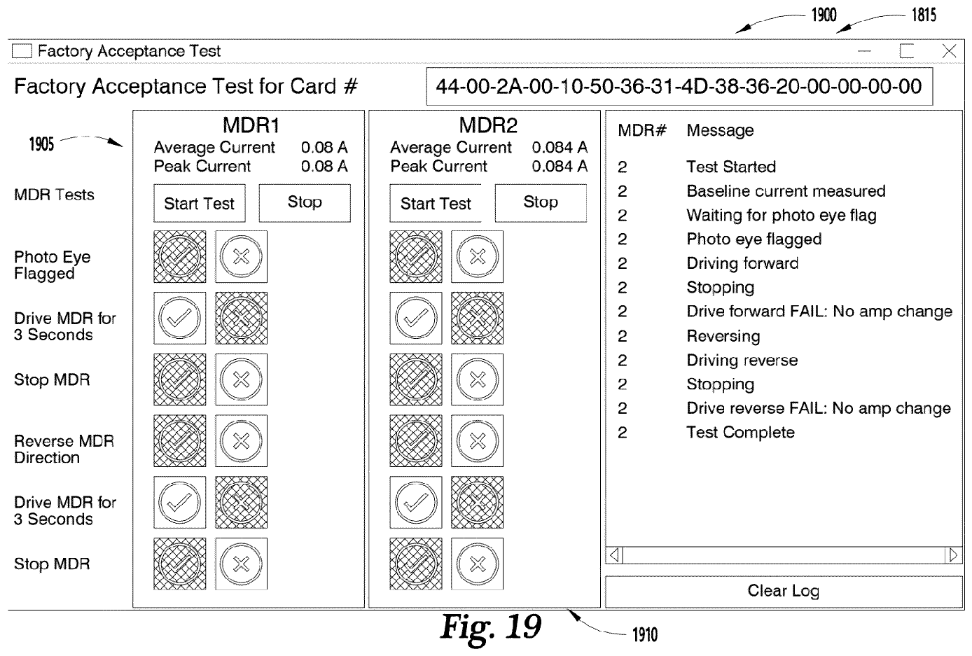

FIGS. 18 and 19 show an example of a user interface 1800. The user interface 1800 includes a card connection button 1805, a firmware flash button 1810, a testing button 1815, and conveyor settings 1820. The card connection button 1805 is used to connect a controller card 120 to the user interface 1800. Once the user interface 1800 is connected to the controller card 120, a user may adjust settings of the controller card 120 via the conveyor settings 1820. The conveyor settings 1820 may include motor speed, acceleration, deceleration, conveyor configuration, conveyor release mode, motor direction, and/or any other desirable settings.

Using the firmware flash button 1810, a user can flash firmware onto one or more controller cards 120. This can be done via the sideband communication system 500 or via the CAN. For example, a user may select a particular controller card 120 via the card connection button 1805 and then via the firmware flash button 1810 the user can transfer updated or new firmware onto the controller card 120.

Using the testing button 1815 a user can access a testing interface 1900. The testing interface 1900 includes a first motorized drive roller (MDR) test 1905 and a second motorized drive roller (MDR) test 1910. The first motorized drive roller (MDR) test 1905 and second motorized drive roller (MDR) test 1910 may be used for factory acceptance testing to determine if a controller card 120 meets the required specifications. The first motorized drive roller (MDR) test 1905 and second motorized drive roller (MDR) test 1910 may test the controller card 120 by driving the MDR, stopping the MDR, reversing the MDR, flagging the photoeye 250, reading the current draw during operation, comparing current draw at idle and operation, and/or any combination thereof.

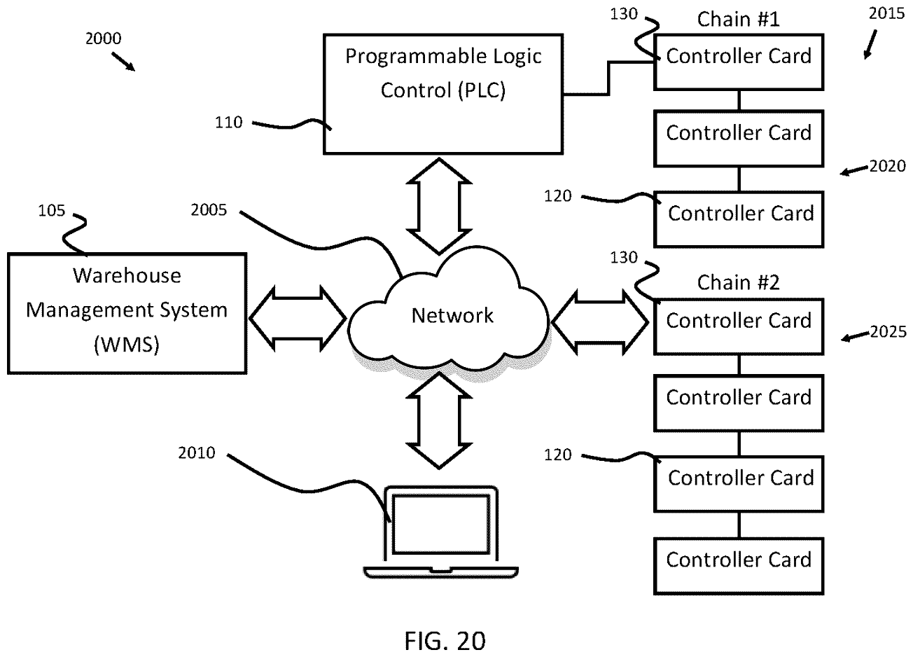

FIG. 20 shows another variation of a conveyor control system 2000. Like in the previous examples, the system 2000 includes the warehouse management system 105, one or more programmable logic controllers 110, one or more controller cards 120, and one or more leader cards 130. For the sake of brevity as well as clarity, these common features and their operation will not be again discussed in great detail below, but please refer to the previous discussion of these common features. Like in the other examples, the warehouse management system 105, the programmable logic controllers 110, and the controller cards 120 are operatively or communicatively coupled together via a network 2005, such as a controller area network (CAN). As depicted, the controller cards 120 in some cases are indirectly coupled to the network 2005 and other components on the network 2005 via the programmable logic controllers 110, and as shown, the controller cards 120 in other cases are directly coupled to the network 2005. The system 2000 includes an operator computer 2010, such as in the form of a laptop computer, desktop computer, smartphone, or other smart device, that is operatively coupled to the network. The operator computer 2010 allows users to interface with and/or control the warehouse management system 105, the programmable logic controllers 110, and the controller cards 120. In most cases, the operator computer 2010 includes a display for displaying various user interfaces and control screens, like the user interface 1800 in FIG. 18 and the testing interface 1900 in FIG. 19.

When the system 2000 in FIG. 20 contains a large number of programmable logic controllers 110 and controller cards 120, communication traffic on the network 2005 can be a concern. Traffic on the network 2005 can be congested such that messages may not be properly transmitted, which in turn can negatively impact the operation of the system 2000. For example, communication packets to and from the controller cards 120 may repeatedly collide so as to interrupt communications on the network 2005. As a result, the warehouse management system 105 may not be able to properly coordinate the activities of the controller cards 120. As will be discussed below, a unique communication technique for the controller cards 120 has been developed to limit communication congestion on the network 2005 as well as elsewhere.

As shown in FIG. 20, the controller cards 120 like in the other examples are typically organized in the form of one or more chains 2015. Each chain 2015 has at least the leader card 130 and can further include one or more additional controller cards 120. In the depicted example, the chains 2015 include a first chain 2020 of controller cards 120 and a second chain 2025 of controller cards 120. As should be recognized, the system 2000 in other examples can include more or less chains 2015 than is depicted in FIG. 20. Within the chains 2015, the controller cards 120 in some forms can be identified with a unique identifier (ID) designated in a similar fashion as described before. In one version, the identification address includes a chain identifier, such as a chain number, that distinguishes the particular chain 2015 from the other chains 2015 and a card identifier, like a card number, that identifies the controller card 120 within the chain 2015. In other variations, the controller cards 120 can be addressed or otherwise identified in other manners.

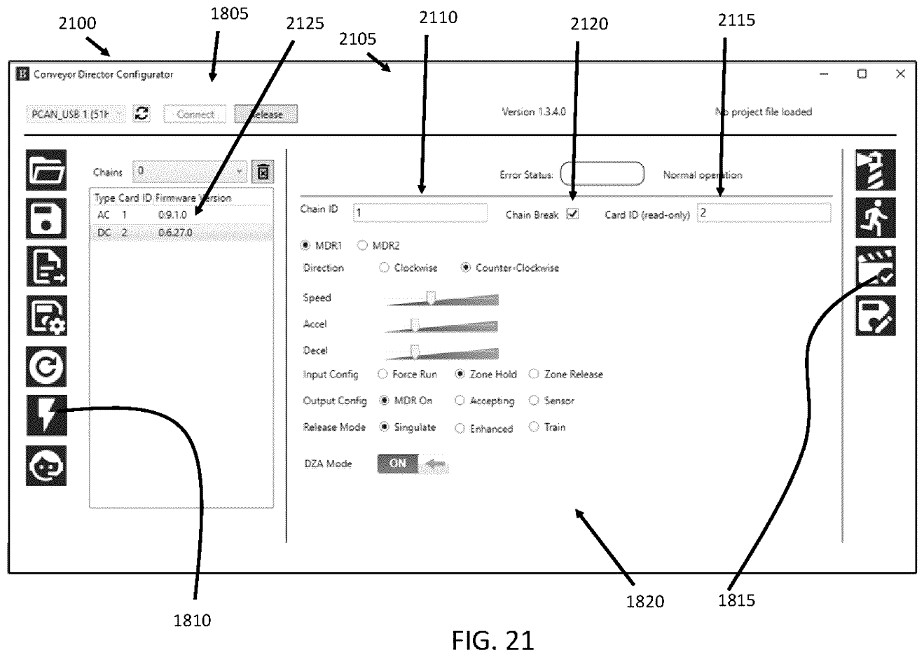

FIG. 21 shows an example of a user interface 2100 that can be shown on the operator computer 2010. As can be seen, the user interface 2100 in FIG. 21 is configured in a similar fashion as the user interface 1800 in FIG. 18. For example, the user interface 2100 in FIG. 21 has the card connection button 1805, the firmware flash button 1810, the testing button 1815, and the conveyor settings 1820 of the type described before with respect to the user interface 1800 in FIG. 18, and the layout of the user interface 2100 in FIG. 21 is basically the same as the user interface 1800 in FIG. 18. Like in the earlier example, the user interface 2100 has the conveyor settings 1820 where the user is able to set or otherwise control the first motorized drive roller and the second motorized drive roller. For example, the user via the conveyor settings 1820 is able to control the direction (e.g., clockwise or counterclockwise rotation), the speed, acceleration, and deceleration of the first and second motorized drive rollers. The input and output configurations as well as the release and other modes can be controlled for the individual controller cards 120. For the sake of brevity as well as clarity, these common features will not be again described in great detail, but please refer to description of the user interface 1800 for FIG. 18.

Once more, the controller cards 120 in one version are identified via a chain identifier and a card identifier that together uniquely identify the controller card 120. As can be seen in FIG. 21, the user interface 2100 shows a card address 2105 for the controller card 120. The card address 2105 includes a chain identifier 2110 for the chain 2015 and a card identifier 2115 that identifies the controller card 120 on the chain 2015. The user interface 2100 further identifies whether or not the controller card 120 is the leader card 130 via a chain break or leader card checkbox 2120. When the leader card checkbox 2120 is checked or otherwise designated, the controller card 120 identified on the user interface 2100 via the card address 2105 is the leader card 130. It should be recognized that the controller card 120 can be identified as the leader card 130 in other manners. As shown, the user interface 2100 further has a firmware version box 2125 that identifies the type and firmware version for the particular controller card 120.

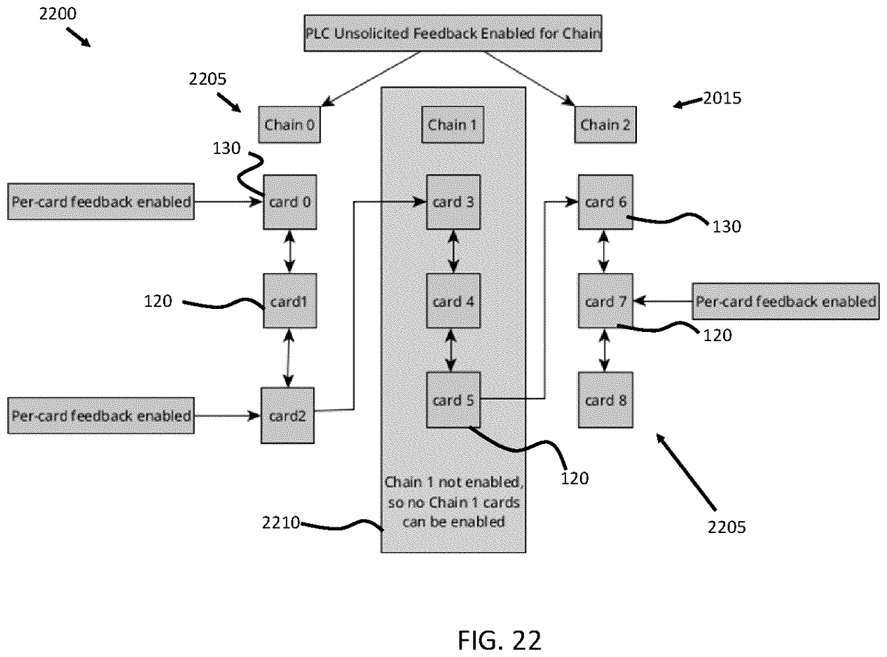

FIG. 22 shows a diagram of an example of a conveyor system 2200 that is configured to reduce network traffic on the network 2005. Like in the other examples, the system 2200 has the chains 2015 of controller cards 120. In the system 2200, individual controller cards 120 and/or chains 2015 of controller cards 120 can be selected or designated to provide feedback over the network 2005 to the warehouse management system 105 and/or the programmable logic controllers 110. In other words, card feedback can be designated on a per controller card 120 basis or a per chain 2015 basis, and feedback from other controller cards 120 can be disabled on a per controller card 120 or a per chain 2015 basis. As shown, the chains 2015 of the system 2200 include one or more enabled chains 2205 where the controller cards 120 are able to communicate or provide unsolicited feedback to the warehouse management system 105 and/or the programmable logic controllers 110 via the network 2005. In some cases, all of the controller cards 120 in the entire enabled chain 2205 are configured to provide unsolicited feedback, and in other cases, only select controller cards 120 in the enabled chains 2205 are able to provide unsolicited feedback so as to further reduce communication congestion. The chains 2015 in the system 2200 further include one or more disabled chains 2210 wherein the controller cards 120 do not provide unsolicited feedback so as to reduce network traffic. The controller card 120 or the chain 2015 can be designated (or not) as providing unsolicited feedback via the controller card 120, the programmable logic controller 110, or the operator computer 2010. In some cases, the controller card 120 is manually designated as providing the unsolicited feedback message, and in other cases, the system 2200 automatically designates the controller card 120 as providing the unsolicited feedback message based on various criteria and/or conditions. In one example, designated controller cards 120 send a message when a photoeye 330, input, jam state, or wake up photoeye 330 change in state occurs.

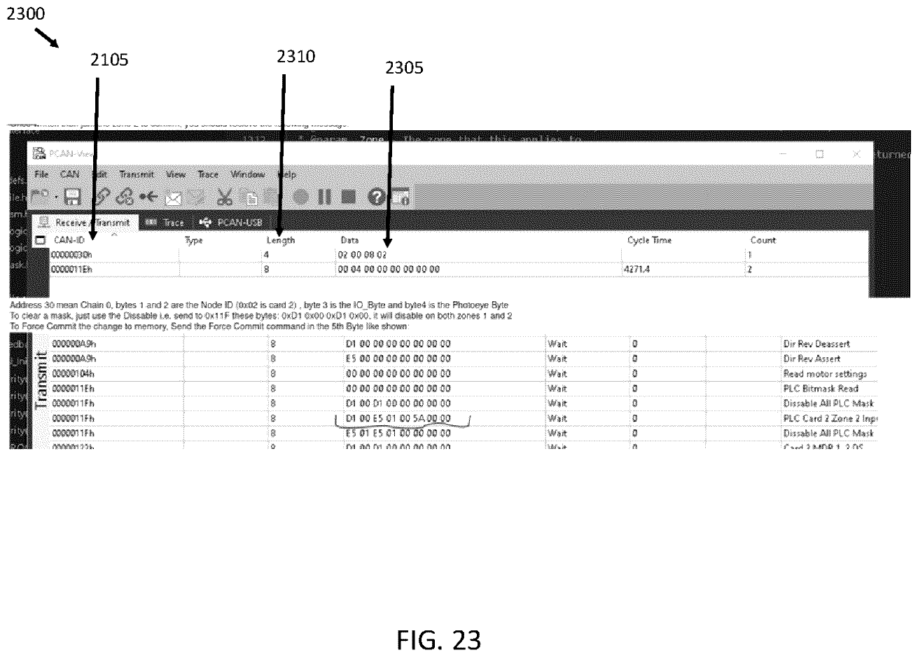

FIG. 23 shows an example of a log screen 2300 that can be displayed on the operator computer 2010. The log screen 2300 has a column that identifies the card address 2105 for the controller card 120 in the row. Typically, the unsolicited message includes a message header with the card address 2105. The message header may include additional information, such as a checksum or other message integrity indicator. Rather than being transmitted on the sideband communication channel 245, the message is normally transmitted on the main communication channel 242 over the network 2005, but in some cases, the feedback message may be partially or fully transmitted via the sideband communication channel 245.

Along with the message header with the card address 2105, the controller card 120 transmits a message body 2305 with data indicative of a state of the controller card 120. Typically, but not always, the controller card 120 only transmits the feedback message when the state of the controller card 120 changes, but in some cases, the controller card 120 may transmit the feedback message at a fixed or variable period, such as to indicate that the controller card 120 is still operational. Depending on the controller card 120, the message bodies 2305 of the unsolicited feedback messages from the controller cards 120 can have different message lengths 2310. For example, a controller card 120 having a single photoeye 330 may transmit a message body 2305 having shorter message lengths 2310 as compared to a controller card 120 having multiple photoeyes 330 or other sensors. The message length 2310 can vary depending on numerous factors, such as the number of conditions monitored by the controller card 120 and the criticality of the controller card 120. Having the feedback messages with different message lengths 2310 can help to further reduce traffic on the network 2005.

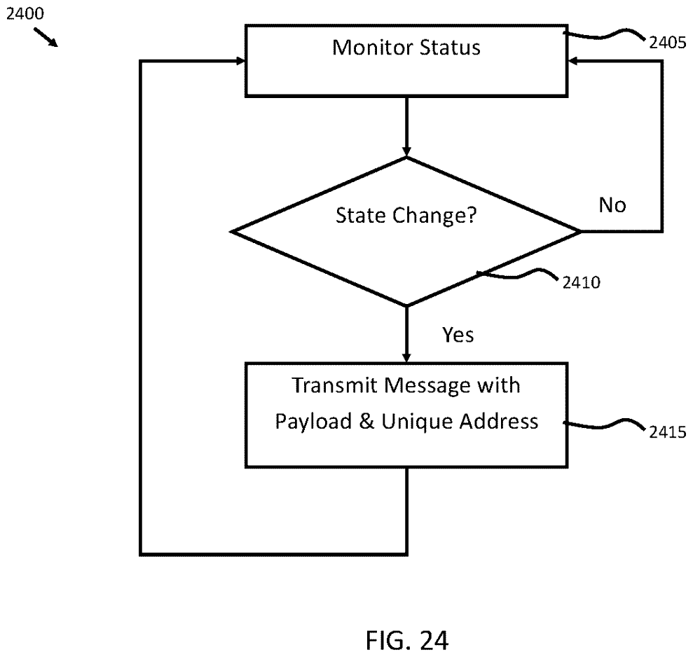

FIG. 24 has a flowchart 2400 that illustrates one example of the technique for sending these unsolicited feedback messages from the perspective of the controller card 120. As noted before, this feedback message is generated by the controller card 120 for example to indicate that the state of a photoeye 330 monitored by the controller card 120, jam status, wakeup eyes, or other configurable input has changed in state. Once more, the card address 2105 used for this message is unique to each chain 2015 to reduce the potential of address collisions. This feature is enabled on a per-card basis. The message is issued in an unsolicited manner, which means that the programmable logic controllers 110 do not have to ask for an update that would bog down the CAN network 2005 with extra traffic. The controller card 120 does not wait to send events on request, but the controller card 120 sends the message immediately, such as for example when the photoeye 330 is triggered.

Looking at the flowchart 2400 in FIG. 24 in conjunction with FIGS. 20 and 22, the feedback controller card 120 monitors the status of the controller card 120 in stage 2405. In stage 2410, if no change in state is detected, such as from the photoeye 330 or other sensors, the controller card 120 continues to monitor the status of the controller card 120 in stage 2405. Otherwise, if a state being monitored by the controller card 120 is changed, the controller card 120 transmits an unsolicited feedback message to the warehouse management system 105 and/or the programmable logic controller 110 in stage 2415. The message at least includes a message header with the card address 2105 and the message body 2305 of the type depicted in FIG. 23. Once more, the message length 2310 of the message body 2305 may vary depending on the controller card 120 or the specific requirements. After the message is sent, the controller card 120 continues to monitor the status of the controller card 120 and various sensors in stage 2405. In most cases, the technique illustrated by the flowchart 2400 in FIG. 24 is performed independently by multiple controller cards 120 at the same time. Even with these multiple controller cards 120 performing this technique simultaneously, CAN traffic is reduced, because the controller cards 120 generally only communicate on an as needed basis, such as when a change in state occurs in stage 2410.

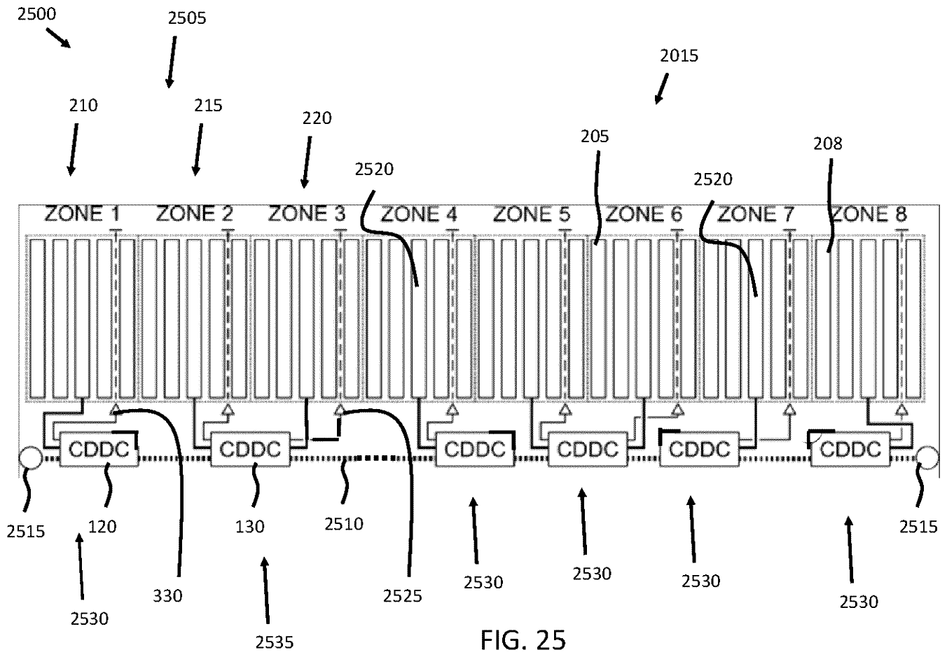

FIG. 25 depicts a conveyor system 2500 according to another variation. Like in the other examples, the system 2500 includes the controller cards 120 for controlling and monitoring one or more conveyors 205 with rollers 208. In the illustrated example, the controller cards 120 and conveyors 205 are arranged in multiple zones 2505 in a similar fashion as described before (e.g., the first zone 210, the second zone 215, the third zone 220, etc.). For the sake of brevity as well as clarity, these common features will not be again described in detail below, but please refer to the previous discussion of these features.

As shown, the controller cards 120 are operatively or communicatively coupled together via one or more communication cables 2510. At opposing ends of the zones 2505, the communication cables 2510 for the controller cards 120 are terminated with termination resistors 2515. In the illustrated example, each zone 2505 has a motorized drive roller 2520 that is operatively coupled to the corresponding controller card 120 for the zone 2505 via an MDR cable, and each zone 2505 further has a zone sensor 2525 operatively coupled to the corresponding controller card 120 via a sensor cable. In one form, the zone sensor 2525 includes one or more photoeyes 330, but the zone sensor 2525 can include other types of sensors.

The system 2500 is designed to facilitate a follow-me operational mode, which reduces network traffic congestion or loading. Generally, in the follow-me operational mode, only one controller card 120, typically the leader card 130, communicates with the programmable logic controller 110 and/or the warehouse management system 105, and the remaining controller cards 120 in the chain 2015 remain silent. In essence, the leader card 130 dictates the operation of the rest of the controller cards 120 in the chains 2015. The system 2500 in the follow-me operational mode can act like a long traditional belt driven conveyor where all of the chains 2015 operate in the same manner.

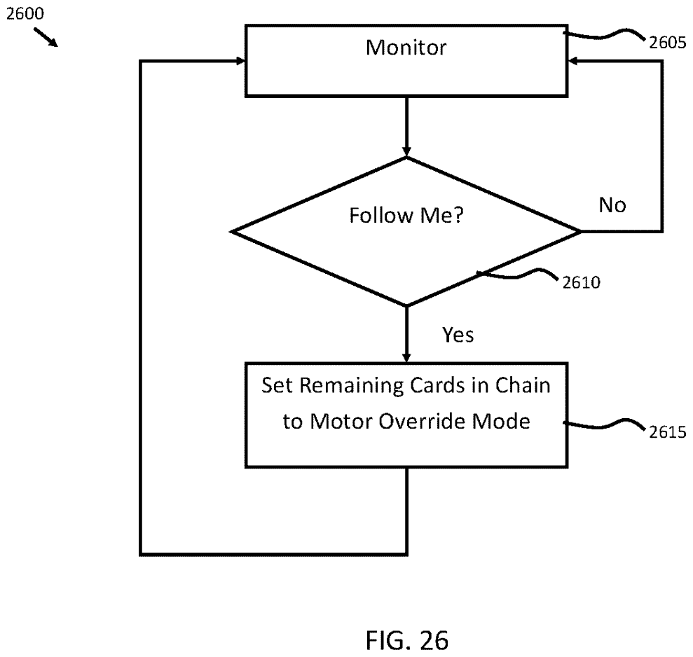

FIG. 26 shows a flowchart 2600 of a technique for setting the follow-me mode in the chain 2015 from the perspective of the leader card 130. In stage 2605, the leader card 130 monitors to see if the follow-me command is received from the programmable logic controller 110 (or the warehouse management system 105), and if the command is not received in stage 2610, the leader card 130 continues to monitor for the command in stage 2605. When the follow-me command is received in stage 2610, the leader card 130 sets every controller card 120 in the chain 2015 into a motor override mode in stage 2615, and afterwards, the leader card 130 returns to stage 2605 to monitor for other commands, such as a command to leave the follow-me mode (e.g., return to a normal operational mode). In most cases, when in the follow-me mode, the leader card 130 sets the remaining controller cards 120 in the chain 2015 into the motor override mode, but in other cases, another controller card 120 besides the leader card 130 can set the controller cards 120 in the chain 2015 into the motor override mode. When in the follow-me operational mode, the zero pressure accumulation (ZPA) mode is disabled for every controller card 120 in the chain 2015.

Referring again to FIG. 25, when in the follow-me operational mode, the controller cards 120 in one or more bypassed zones 2530 are placed in the motor override mode, and the leader card 130 in the active zone 2535 controls the operation of the remaining controller cards 120 in the chain 2015 such that these controller cards 120 follow the operational mode of the leader card 130. The leader card 130 (i.e., the controller card 120 with the follow-me mode active) sends override commands via the communication cable 2510 when any input pin is toggled or if commanded by the programmable logic controller 110 (or even the warehouse management system 105). The leader card 130 is further configured to tell every controller card 120 in the chain 2015 via the communication cable 2510 to reverse direction if a reverse pin is toggled or if commanded by the programmable logic controller 110 (or the warehouse management system 105).

During normal operation, such as when in the ZPA mode, the conveyor 205 in a chain 2015 typically moves when the zone sensor 2525 for the chain 2015 is triggered. The controller card 120 for the triggered chain 2015 via the communication cable 2510 notifies the upstream controller card 120 and the downstream controller card 120 that the motorized drive roller 2520 in the triggered conveyor 205 (or, in the case of AC, the solenoid) is active, and the ZPA logic functions accordingly. In the follow-me mode, the zone sensors 2525 are still active, but the controller card 120 no longer allows any motorized drive roller 2520 or solenoid to activate. In one version, the only components that activate movement of the conveyors 205 are the input pins on the leader card 130 (e.g., port 3 and 4 on the leader card 130). In one version, the signals from input pins of the leader card 130 are transmitted via the communication cable 2510. When the input pin is active, all of the motorized drive rollers 2520 (or solenoids) in the chains 2015 are activated. The motorized drive rollers 2520 remain active until all input pins are inactive. If the reverse pin is active (e.g., port 10 of the leader card 130) then all of the motorized drive rollers 2520 reverse direction. The direction remains reversed until the reverse pin is inactive.

To prevent voltage spikes, which could trip circuit breakers or other electrical protection devices, one or more controller cards 120 can have a predesignated, random, or pseudorandom delay value (e.g., via a random seed) that delays activation of the motorized drive roller 2520 (or solenoid) for the chain 2015. For example, when the input pin of the leader card 130 is active, one or more downstream controller cards 120 in the bypassed zones 2530 of the chain 2015 can delay powering up the motorized drive rollers 2520 by one or more different delay values (e.g., 10 to 30 millisecond delays). As a result, not all of the motorized drive rollers 2520 turn on at the same time. This delay can also occur when powering in the reverse direction. In one variation, the controller card 120 multiplies the same random seed the controller card 120 uses for an indexing delay to generate the delay value for turning on the motorized drive roller 2520.

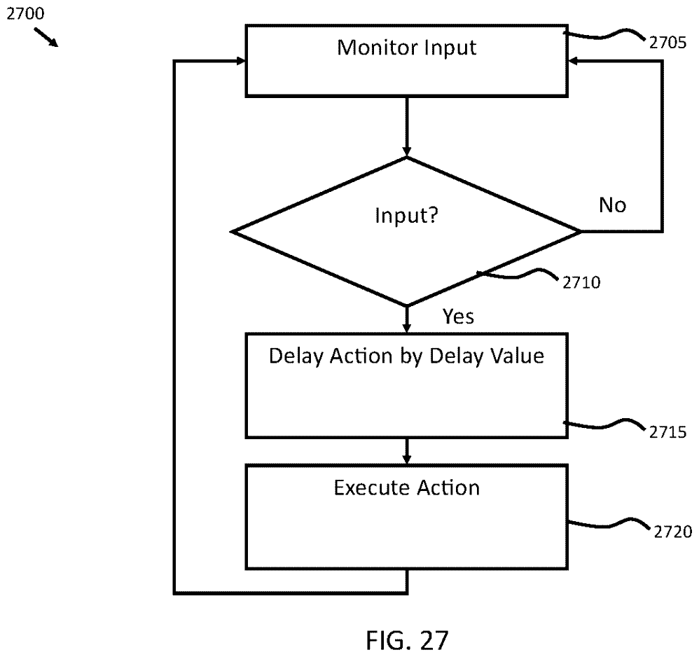

FIG. 27 shows a flowchart 2700 that generally depicts this activation delay technique for reducing power demand spikes in the system 2500 from the perspective of the controller cards 120 downstream from the leader card 130 in the chain 2015. In stage 2705, the controller card 120 monitors the input pins (e.g., actual or virtual) from the leader card 130 on the communication cable 2510, and in stage 2710, the controller card 120 determines whether or not one of the pins (e.g., forward or reverse pins) has been activated. If no input is received in stage 2710, the controller card 120 continues to monitor for input signals on the pins in stage 2705. When an input pin is active in stage 2710, such as when the forward input pin or the reverse pin is active, the controller card 120 delays activation of the motorized drive roller 2520 by the delay time value in stage 2720. Once the delay time has elapsed in stage 2715 (e.g., after a 10 to 30 millisecond delay), the controller card 120 in stage 2720 activates or drives the motorized drive roller 2520 (or solenoid) in the direction set by the input signal, such as in the forward or reverse directions. Once the action is executed in stage 2720, the controller card 120 returns to monitoring the input in stage 2705. In one version, the delay time in stage 2715 is individually set in memory for each controller card 120 in the chain 2015 via the warehouse management system 105, the programmable logic controller 110, and/or the leader card 130. The controller card 120 in some cases can also set the delay time via a random or pseudorandom number generator. In other versions, the delay times can be set for groups of controller cards 120 in the chain 2015. The controller card 120 in some cases dynamically sets the delay value depending on various conditions of the system 2500, and in other cases, the delay times can be a static or fixed value.

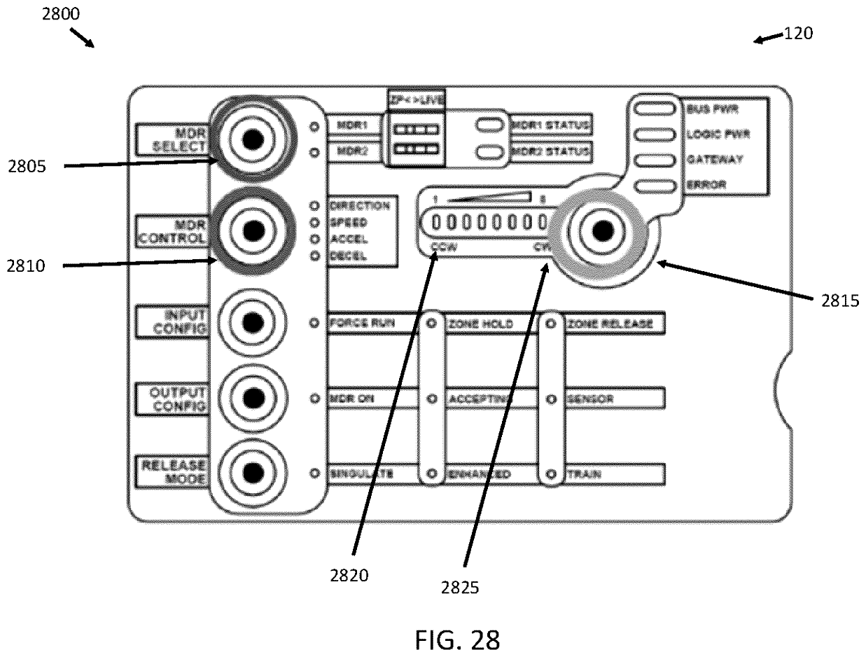

In another variation, signals from the warehouse management system 105 and/or the programmable logic controller 110 act as virtual pins to control the operation of the controller cards 120 during the follow-me mode. As an example, the virtual pins signal sent from the programmable logic controller 110 (e.g., via offset address 0x0E for the input pins and offset address 0x14 for the reverse pin) act the same as physical pins on the leader card 130. Although this example uses the programmable logic controller 110, it should be recognized that the user interface for the physical controller card 120 or configurator program/interface on the operator computer 2010 can be used to control operation during the follow-me or other modes. For instance, turning to FIG. 28, the follow-me mode can be entered by a user interface 2800 for the controller card 120. The circles in FIG. 28 highlight the buttons that are pressed or otherwise activated in the user interface 2800. To start the follow-me mode, the controller card 120 in this example is placed into a programming mode by holding down an MDR control button 2805 and an MDR select button 2810 until a countdown is finished. Once the countdown is finished, an increment button 2815 in the user interface 2800 is pressed to enter the follow-me mode. When in the programming mode, an illuminated counterclockwise indicator (CCW indicator) 2820 in the user interface 2800 means the follow-me mode is disabled, and an illuminated clockwise indicator (CW indicator) 2825 in the user interface 2800 means the follow-me mode is enabled. It should be recognized that other indicators in the user interface 2800 (or elsewhere) can be used to indicate the operational state of the controller card 120.

Commonly, the controller cards 120 may be powered down or otherwise deactivated during repair or to address other issues, such as jamming. When restarting the system 2500 or individual zones 2505, the controller cards 120 are typically rebooted. During development of the system 2000, it was found that the controller cards 120, such as shown in FIGS. 20 and 25, would automatically activate the motorized drive roller 2520 during bootup so as to index the conveyors 205. However, this automatic indexing caused all sorts of issues. For example, this automatic indexing could cause boxes or other containers to jam or be improperly indexed on the conveyor 205. To address these as well as other issues, the individual controller cards 120 are able to be set in a zero-index mode where the controller cards 120 do not activate the motorized drive roller 2520 or otherwise take any action to cause the rollers 208 of the conveyors 205 to move during start-up or booting of the controller card 120. When in the zero-index mode, the controller card 120 does not index on bootup, but the ZPA mode remains active.

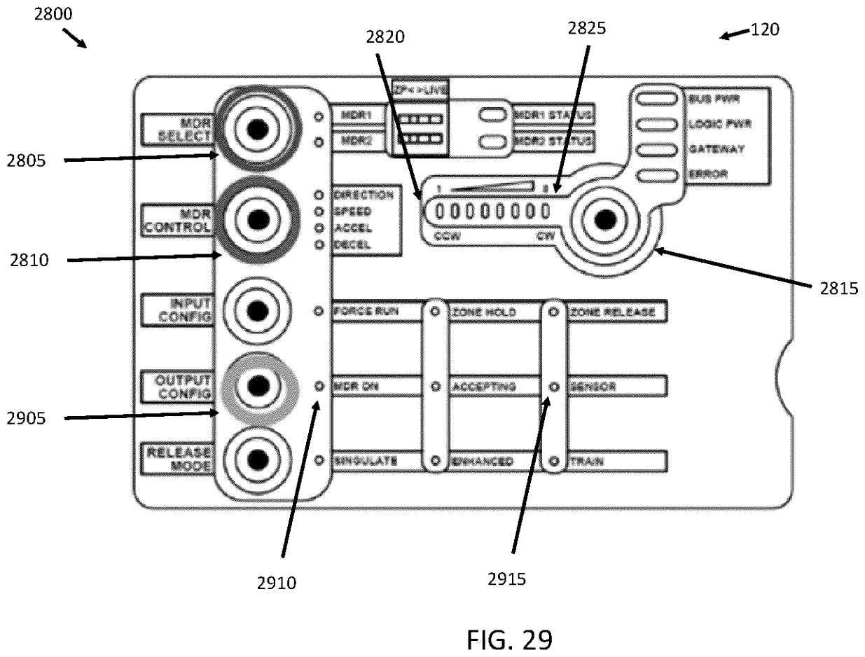

The zero-index mode can be set by the warehouse management system 105, the programmable logic controller 110, and/or a user via a configuration user interface on the operator computer 2010. The zero-index mode can also be set via the user interface 2800 of the controller card 120, such as is depicted in FIG. 29. Once more, the circles in FIG. 29 highlight the buttons that are pressed or otherwise activated in the user interface 2800 to activate the zero-index mode. To start the zero-index mode, the controller card 120 in this example is placed into a programming mode by holding down the MDR control button 2805 and the MDR select button 2810, and then an output configuration button 2905 on the user interface 2800 is pressed. As can be seen, the user interface 2800 near the output configuration button 2905 has a motorized drive roller indicator 2910 and a sensor indicator 2915 that indicate the state of the zero-index mode when in the programming mode. In this example, when in the programming mode, the motorized drive roller indicator 2910 is illuminated when the zero-index mode is deactivated, and the sensor indicator 2915 is illuminated when the zero-index mode is activated. The user is able to toggle between activating and deactivating the zero-index mode by pressing or otherwise activating the output configuration button 2905.

Again, when the zero-index mode is active (e.g., the sensor indicator 2915 is shining), the controller card 120 does not index the motorized drive roller 2520 on bootup. This zero-index mode upon booting allows robots and/or personnel to adjust, remove, or place boxes or other containers on the conveyor 205 without the boxes getting moved by the indexing operation. The controller cards 120 send messages to each other as usual (e.g., indicating zone occupied, etc.). Other than not indexing, the conveyor 205 operates normally in the zero-index mode.

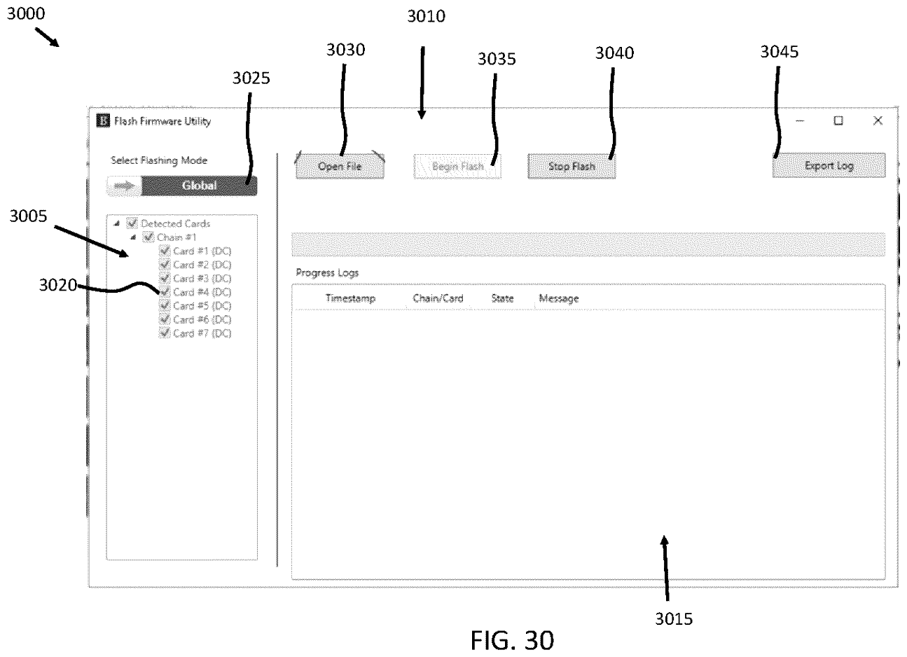

As noted before, the system 2000 is able to facilitate global programming or reprogramming multiple controller cards 120 at the same time. For example, the firmware on multiple controller cards 120 can be generally flashed or replaced at the same time. As another example, this global programming technique can be used to enable or disable controller cards 120 or chains 2015 of controller cards 120 for the unsolicited feedback technique described above with reference to FIGS. 22, 23, and 24. FIG. 30 shows an example of a user interface 3000 that can be displayed on the operator computer 2010 to facilitate partial or global programming of the controller cards 120. As can be seen, the user interface 3000 includes a selection pane 3005, an action area 3010, and a log pane 3015. In the illustrated example, the selection pane 3005 includes a tree diagram of the chains 2015 and the controller cards 120 within the chains 2015. In the depicted example, the tree diagram in the selection pane 3005 only depicts chains 2015 and controller cards 120 detected by the warehouse management system 105, but it should be recognized that the selection pane 3005 can display undetected controller cards 120 or other equipment. Each entry in the selection pane 3005 includes a selection box 3020 where the user is able to select or deselect chains 2015 and/or controller cards 120 that are desired to be updated. For example, when the selection box 3020 for a particular chain 2015 is selected, all of the controller cards 120 in the chain 2015 are initially selected, which is indicated by a checkmark in the selection box 3020, and the user can deselect individual controller cards 120 and/or chains 2015 by clicking on the checked selection box 3020. It should be appreciated that controller cards 120 and/or chains 2015 can be selected for updating by using different types of interfaces. The global updating technique will be described with reference to flashing firmware updates across multiple controller cards 120 and/or chains 2015, but this technique can be used to make other types of updates, such as for updating software, data, settings, and the like.

The action area 3010 includes one or more user controls, like buttons, dropdown lists, boxes, fields, etc., that are used for performing the global update technique. In the illustrated example, the action area 3010 of the user interface 3000 includes a mode selector 3025, an open file button 3030, a begin button 3035, a stop button 3040, and an export button 3045. With the mode selector 3025, the user is able to select the type of update and how the update is conducted. As will be explained in greater detail below, the update can occur in a serial fashion where controller cards 120 are individually updated in a sequential manner or in a parallel fashion where the controller cards 120 are updated simultaneously (or in a near simultaneous manner). The open file button 3030 is used to open or select the firmware file that will be used to update the controller cards 120 selected in the selection pane 3005. The begin button 3035 is used to start the update process, and the stop button 3040 is used to stop the update process before completion. The log pane 3015 is used to display the status or progress of the controller cards 120 and/or chains 2015 being updated, and a log of this progress can be exported via the export button 3045.

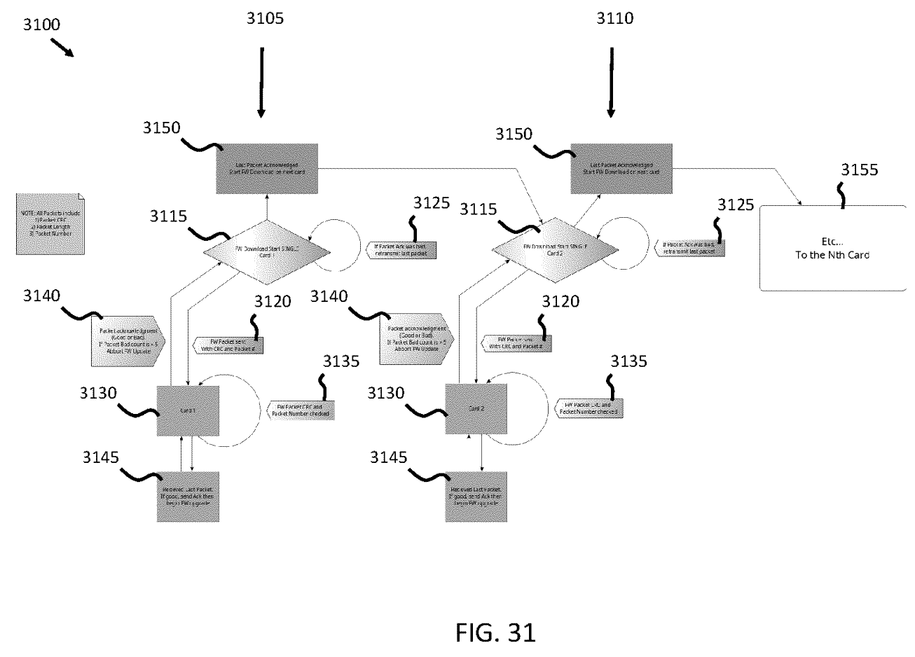

FIG. 31 is a diagram 3100 that depicts one version of a serial or sequential updating technique for the controller cards 120. Generally, with this technique, the firmware is downloaded and updated one controller card 120 at a time. In most cases, the communications using this technique are through the main communication channel 242 (e.g., the network 2005), rather than through the sideband communication channel 245, but in some variations, this technique can use the sideband communication channel 245. The diagram 3100 in FIG. 31 shows two branches, a first branch 3105 and a second branch 3110. The first branch 3105 depicts the general actions for updating the first controller card 120, and the second branch 3110 depicts the general actions for updating the second controller card 120 after the first one is updated. As can be seen, the actions or stages for each card are the same, but these actions are performed for the corresponding controller card 120. A similar process is performed for subsequent cards that are updated using this serial update process. For the sake of brevity as well as clarity, the various actions will be described with reference to the first branch 3105, but it should be recognized that the subsequent controller cards 120, like the second controller card 120 in the second branch 3110, are updated in the same or similar fashion.

In addition to FIG. 31, the technique will be described with reference to FIGS. 20, 25, and 30, but it should be appreciated that this technique can be performed by differently configured conveyor systems. When describing this technique with respect to the diagram 3100 in FIG. 31, the warehouse management system 105 will be described as transmitting the firmware or other updates to the current controller card 120, but other components, such as the programmable logic controller 110 or the operator computer 2010, can be used to transmit the updates to the controller card 120. In stage 3115, the warehouse management system 105 downloads and/or creates a packet containing all or part of the firmware update to the first controller card 120, such as the first one selected via the selection box 3020 in the selection pane 3005 of FIG. 30. The warehouse management system 105 downloads or otherwise obtains the firmware or other update in stage 3115. For example, the warehouse management system 105 can download the firmware update from an external server, hard drive, or other storage device. In another example, the update can be already stored in memory on the warehouse management system 105. If needed, the warehouse management system 105 processes the update into separate packets. In this example, the transmitted packets each at least include a packet cyclic redundancy check (CRC), the length of the packet, the packet number, and the packet payload or body containing at least a portion of the firmware or other data. The packet is further addressed to the specific controller card 120 being updated. As noted before, the address in some cases includes the card address 2105 with the chain identifier 2110 and the card identifier 2115, such as was described above with respect to FIGS. 21 and 23. It should be recognized that the packet can be structured differently and contain different information in other variations. Via the network 2005, the warehouse management system 105 transmits the packet to the first controller card 120 to be updated in stage 3120. In stage 3125, the warehouse management system 105 checks for an acknowledgement from the controller card 120. If the acknowledgement indicates that the packet was bad in stage 3125, the warehouse management system 105 retransmits the same packet. If the packet is acknowledged as being good or okay, the warehouse management system 105 transmits the next packet that is structured in a similar fashion as described before.

In stage 3130, the controller card 120 receives the transmitted packet, and the controller card 120 receiving the packet in stage 3135 checks the CRC, the packet size, and/or the packet number for the received packet. The controller card 120 in stage 3140 sends an acknowledgement over the network 2005 back to the warehouse management system 105 that transmitted the packet. If the controller card 120 finds the CRC, the packet size, and/or the packet number in stage 3135 to be incorrect or otherwise irregular, the controller card 120 in the acknowledgement indicates that the packet was bad. It should be appreciated that the packet integrity can be checked in other manners (e.g., via a checksum). Once more, the warehouse management system 105 in stage 3125 retransmits the same packet that was indicated as being bad in the acknowledgement. In one version, when the number of bad packets exceeds a limit, such as 5 bad packets, the warehouse management system 105 aborts the firmware (FW) update. It should be recognized that the bad packet limit can be different in other examples.

As noted before, the warehouse management system 105 in stage 3115 and stage 3120 continues to send the next packet over the network 2005 as each previously sent packet is acknowledged as being good, and these packets are processed in the same fashion as described before. Once the last packet is received, determined to be good in stage 3135, and acknowledged as good in stage 3140, the controller card 120 in stage 3145 begins the firmware upgrade. The last packet can be designated or determined in several ways. For example, the last packet can include a flag or other indicator that the packet is the last packet. In another example, the total number of packets sent is a fixed number, and the controller card 120 can determine the last packet based on the packet number coinciding with the total number of packets. After the warehouse management system 105 determines the last packet has been acknowledged as being good, the warehouse management system 105 in stage 3150 proceeds to the second branch 3110 where the warehouse management system 105 performs a similar process for the next controller card 120 that needs to be updated. As indicated in stage 3155, the warehouse management system 105 proceeds with updating the remaining designated controller cards 120 in the same fashion as described above.

During development, it was found that the sequential or serial updating technique described above with reference to FIG. 31 significantly increased traffic congestion and time to perform the update. For example, while the time to update each individual controller card 120 might just take 30 seconds to a minute (or more), the total time to update every controller card 120 can be significant, such as with deployments at large installations having hundreds or even thousands of controller cards 120 at a facility. Likewise, the same firmware or other information is transmitted to multiple controller cards 120, which unnecessarily increases network congestion.

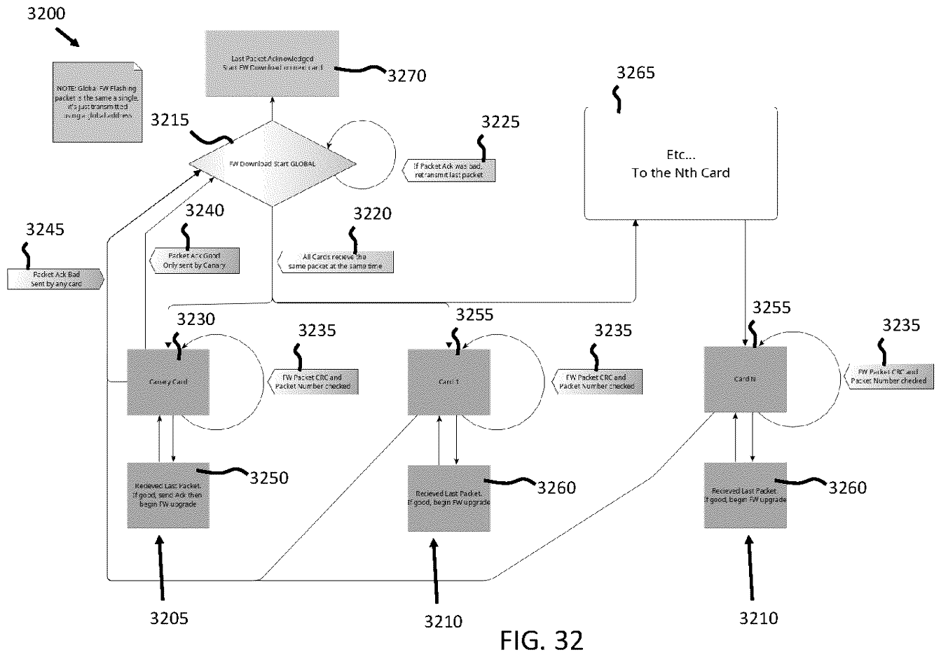

A unique parallel global programming or updating technique, which has been developed to address these as well as other issues, will now be described with reference to a diagram 3200 in FIG. 32. With this technique, the warehouse management system 105 and/or the programmable logic controller 110 pushes the firmware to every selected controller card 120 and makes firmware flashing generally take the same amount of time as a single controller card 120. Firmware flashing of the controller cards 120 via the user interface 3000 on the operator computer 2010 can be done globally and simultaneously. While this technique will be described as flashing firmware on the controller cards 120, it should be recognized that updates of other programs and/or data can occur using this technique. In most cases, the communications using this technique are through the main communication channel 242 (e.g., the network 2005), rather than through the sideband communication channel 245, but in some variations, this technique can use the sideband communication channel 245. When entering the global programming mode, one controller card 120 is delegated as the lead or canary controller card 120. In one version, the canary controller card 120 continues to blink during the flashing process, and the canary controller card 120 reports any errors that are seen during this flashing process.

Referring to FIGS. 20 and 32, the diagram 3200 includes a canary branch 3205 that depicts the actions performed by the canary controller card 120 in the system 2000 and one or more follower branches 3210 that depict the action performed by follower controller cards 120. The canary controller card 120 in one version is manually designated by the user via the operator computer 2010, the programmable logic controller 110, and/or the user interface 2800 for the designated canary controller card 120. In another version, the canary controller card 120 is automatically designated by the warehouse management system 105 and/or the programmable logic controller 110. Typically, but not always, the canary controller card 120 is usually the one that has the most difficulty in receiving (or transmitting) messages transmitted over the network 2005. For example, the canary controller card 120 may be a controller card 120 located at a particular electromagnetically noisy or other disruptive area that disrupts communications, such as by an electric motor, power supply, transmitter, furnace, or other device. In some specific versions, such as in especially noisy facilities, the technique can use more than one canary controller card 120.

With this technique, the packets containing the firmware and/or other updates are transmitted using a global address, rather than a specific card address 2105. These firmware update packets can be sent from the warehouse management system 105, the programmable logic controller 110, the operator computer 2010, or another device over the network 2005. For explanation purposes only, the technique will be described with respect to the warehouse management system 105 transmitting the packets, but it should be appreciated that the programmable logic controller 110, the operator computer 2010, or other device can transmit these packets. The selected controller cards 120, which are being updated, monitor for packets having the global address. The canary controller card 120 along with one or more follower controller cards 120 receive and process these packets from the network 2005. In essence, all of the controller cards 120 receive the packets in parallel. Depending on if the received packet is good or bad, the canary controller card 120 can send a good or bad packet acknowledgement over the network 2005 to the packet transmitting device (e.g., the warehouse management system 105). The good packet receipt acknowledgement is only sent from the canary controller card 120. The follower controller cards 120 do not send this good packet acknowledgement. However, any of the follower controller cards 120 can send a bad packet acknowledgement. When the warehouse management system 105 receives a bad packet acknowledgement from the canary or follower controller cards 120, the warehouse management system 105 retransmits the same packet. Once the last packet for the update is successfully received by all of the controller cards 120, the controller cards 120 perform the update process in parallel. For instance, the downloaded firmware update is flashed on all of the controller cards 120 generally at the same time. It should be noted that due to communication and processing delays that all of the controller cards 120 may not flash the firmware at the same exact time, but the firmware flashing may occur around the same general time.

Looking at the diagram 3200 in FIG. 32, the warehouse management system 105 downloads or otherwise obtains the firmware or other update in stage 3215. For example, the warehouse management system 105 can download the firmware update from an external server, hard drive, or other storage device. In another example, the update can be already stored in memory on the warehouse management system 105. In some cases, the warehouse management system 105 converts the firmware update into separate packets, and in other cases, the updates are pre-processed and already stored as the separate packets. In this example, the transmitted packets each at least include a packet cyclic redundancy check (CRC), the length of the packet, the packet number, and the packet payload or body containing at least a portion of the firmware update or other data. The packet is further addressed to the general address. It should be recognized that the packet can include other information and/or structured differently. The warehouse management system 105 in stage 3220 transmits the packet at the same time over the network 2005 to all of the controller cards 120 being updated, including the canary controller card 120 and the follower controller cards 120. The warehouse management system 105 in stage 3225 monitors the network 2005 for an acknowledgement for the recently transmitted packet. If the acknowledgement indicates that the packet transmission was successful or good, the warehouse management system 105 transmits the next packet. Otherwise, if the acknowledgement indicates that the packet transmission was unsuccessful or bad, the warehouse management system 105 retransmits the same packet to all of the controller cards 120 being updated using the global address. In another variation, the warehouse management system 105 only retransmits the same packet to the specific card address 2105 of the controller card 120 that sent the bad packet acknowledgement.

As shown in the canary branch 3205, the canary controller card 120 monitors the network 2005 for packets addressed to the global address in stage 3230. In stage 3235, the canary controller card 120 checks the CRC, the packet size, and/or the packet number for the received packet. If the packet is okay or good, the controller card 120 in stage 3240 sends a packet good acknowledgement over the network 2005 back to the warehouse management system 105 that transmitted the packet. Only the canary controller card 120 transmits the good packet acknowledgement, and the other, follower controller cards 120 do not transmit this good packet acknowledgement. Having only the canary controller card 120 transmitting the good packet acknowledgement reduces network congestion and avoids confusing the warehouse management system 105. If the canary controller card 120 finds the CRC, the packet size, and/or the packet number in stage 3235 to be incorrect or otherwise irregular, the canary controller card 120 in the acknowledgement indicates that the packet was bad in stage 3245. As will be explained below, the other or follower controller cards 120 are also able to transmit the bad packet message in stage 3245. It should be appreciated that the packet integrity can be checked in other manners (e.g., via a checksum). When the bad packet acknowledgement of stage 3245 is received, the warehouse management system 105 retransmits the same packet in stage 3225.

As noted before, once the good packet acknowledgement is received by the warehouse management system 105 in stage 3240 and no bad packet acknowledgements from stage 3245 are received, the warehouse management system 105 transmits the next packet using the global address in stage 3225. The warehouse management system 105 continues to transmit packets in a similar fashion until the last packet is successfully transmitted. Once the last packet is received, determined to be good in stage 3235, and acknowledged as good in stage 3240, the canary controller card 120 in stage 3250 begins the firmware or other update (e.g., flash the firmware). The last packet can be designated or determined in several ways. For example, the last packet can include a flag or other indicator that the packet is the last packet. In another example, the total number of packets sent is a fixed number, and the canary controller card 120 can determine the last packet based on the packet number coinciding with the total number of packets.

While in some cases a single follower controller card 120 (i.e., besides the canary controller card 120) can be updated with this technique, this technique can be very helpful in situations having more than one follower controller card 120. The follower branch 3210 in the FIG. 32 diagram 3200 represents the actions performed by the follower controller cards 120. The canary and follower controller cards 120 receive the same packet at generally the same time. In stage 3255, the follower controller card 120 receives the packet from the warehouse management system 105 over the network 2005, and the follower controller card 120 checks the packet in stage 3235 in the same manner as described before. Once more, the follower controller cards 120 do not send good packet acknowledgements (in stage 3240). However, the follower controller cards 120 are able to send back to the warehouse management system 105 bad packet acknowledgements in stage 3245, and the warehouse management system 105 then retransmits the same packet in stage 3220 and stage 3225. Once the last packet is received, the follower controller cards 120 perform the update (e.g., flash the firmware) in stage 3260. The last packet can be determined in the same fashion as described above with respect to stage 3250. As noted in stage 3265, the remaining follower controller cards 120 can be updated in a similar manner. The warehouse management system 105 can also monitor the status of the controller cards 120 to confirm if the updates properly occurred and take appropriate corrective actions in stage 3270. Once the update process is properly finished, the system 2000 can proceed to the next update if needed in stage 3270.

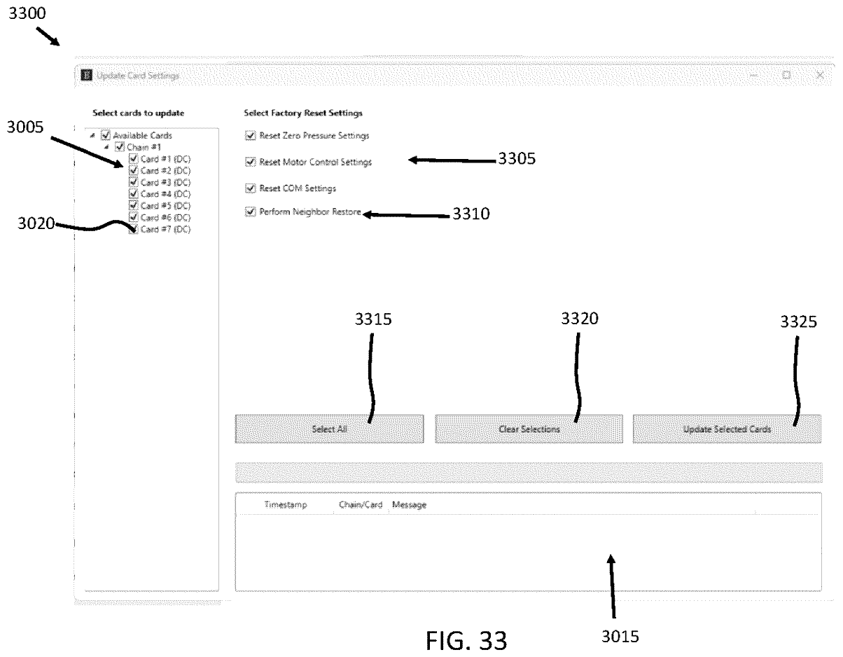

In some cases, the controller cards 120 require a factory reset to clear certain settings in memory. Performing this for individual controller cards 120 can be quite labor intensive. Unique techniques have been developed for clearing these settings or data in the memory of multiple controller cards 120. These techniques can be accomplished via the programmable logic controllers 110 or the operator computer 2010. FIG. 33 shows one example of a user interface 3300 to facilitate this factory reset process. As can be seen, the user interface 3300 includes the selection pane 3005 with the selection boxes 3020 and the log pane 3015 of the type described above. For the sake of brevity as well as clarity, these features will not be again described in great detail below, but please refer to the previous discussion.

The controller cards 120 that need to be reset can be readily selected via the selection boxes 3020 in the selection pane 3005 of the user interface 3300. The user interface 3300 further includes one or more reset options 3305 where the user is able to select the settings or other data that should be reset in the selected controller cards 120. In the illustrated example, the reset options 3305 are in the form of checkboxes, but the reset options 3305 can include other types of interfaces. As shown, the zero pressure settings, motor control settings, and communication settings for the selected controller cards 120 can be reset using the reset options 3305. The user interface 3300 further includes a neighbor restore option 3310 that allows the controller cards 120 to be restored, such as in the manner for example as described above with respect to FIG. 16. After the settings are reset in accordance with the reset options 3305, settings can be pushed to neighbors when the neighbor restore option 3310 is selected. The user interface 3300 further has a select all button 3315 that allows the user to select all of the checkboxes from the reset options 3305 and the neighbor restore option 3310, and the user interface 3300 further has a clear selection button 3320 for deselecting these checkboxes. As shown, the user interface 3300 has an update button 3325 that performs the reset in accordance with the selections for the reset option 3305 and the neighbor restore (if the neighbor restore option 3310 is selected) for the controller cards 120 selected in the selection pane 3005.

This resetting of the controller cards 120 can occur in a number of manners. For example, the controller cards 120 can be reset and/or restored using a sequential technique in a fashion similar to that described above with respect to FIG. 31. In another example, the resetting and/or neighbor restoring of the controller cards 120 can occur in a parallel manner that is similar to the fashion described above with reference to FIG. 32.

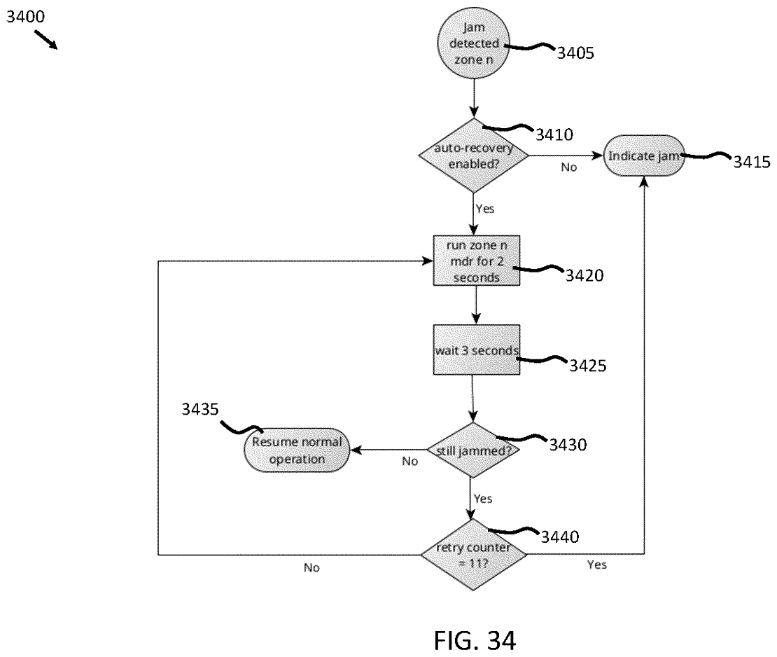

FIG. 34 shows a flowchart 3400 that depicts a unique technique for conveyor systems to self-recover from jammed boxes and/or containers. The technique will be described with reference to the FIG. 20 system 2000 and the FIG. 25 system 2500, but it should be recognized that other conveyor systems can use this technique. Moreover, the controller card 120 will be described as performing the various actions, but it should be appreciated that other components, like the warehouse management system 105, the programmable logic controllers 110, and/or the operator computer 2010 can perform this method. This self-jam recovery can be enabled on a per controller card 120 basis or across multiple controller cards 120. When enabled, the controller card 120 runs the motorized drive roller 2520 for the jammed zone 2505 for a specified runtime period (e.g., two seconds) and then waits for a specified wait period (e.g., three seconds). This process is repeated up to an attempt limit (e.g., ten times) before giving up and declaring the zone 2505 jammed.

In stage 3405, the controller card 120 via the zone sensor 2525 detects that the second chain 2025 is jammed. The controller card 120 in stage 3410 determines whether or not the auto-recovery function was enabled. If not, the controller card 120 in stage 3415 issues an alert or otherwise indicates that the zone 2505 is jammed, such as via an indicator on the controller card 120, the operator computer 2010, or elsewhere. When auto-recovery is enabled in stage 3410, the controller card 120 in stage 3420 runs the motorized drive roller 2520 for a specified runtime period. In the depicted example, this runtime period is two seconds, but the runtime period can be different in other examples. After the controller card 120 stops the motorized drive roller 2520, the controller card 120 in stage 3425 waits for a specified wait period. In the illustrated example, this wait period is three seconds, but the wait period can be different in other examples. After waiting, the controller card 120 via the zone sensor 2525 determines whether or not the zone 2505 is still jammed in stage 3430. If the zone 2505 is no longer jammed, the controller card 120 in stage 3435 resumes normal operation.

Otherwise, if the zone 2505 is still jammed in stage 3430, the controller card 120 determines if the number of auto-recovery attempts exceeds an attempt limit. The controller card 120 maintains a retry counter in memory that indexes during each attempt. In the depicted example, the recovery attempt limit is ten times, but the recovery attempt limit can be different in other variations. When the attempt limit has not been exceeded in stage 3440, the controller card 120 returns to stage 3420 and runs the motorized drive roller 2520 again for the specified runtime period. When the attempt limit is exceeded in stage 3440, the controller card 120 in stage 3415 issues an alert or otherwise indicates that the zone 2505 is jammed, such as via an indicator on the controller card 120, the operator computer 2010, or elsewhere.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example, if the stated value is 4.375, then use of the term “about 4.375” generally means a range between 3.9375 and 4.8125.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Channel” generally refers to a long, narrow groove in a surface of an object.

“Checksum” generally refers to data derived from a block of digital data for the purpose of detecting errors that may have been introduced during its transmission and/or storage. Typically, the checksum data is relatively small-sized. By themselves, checksums are often used to verify data integrity, but checksums are not typically relied upon to verify data authenticity. The procedure or process that generates the checksum from a data input is called a checksum function or checksum algorithm. Depending on the use case, a good checksum algorithm will usually output a significantly different value, even for small changes made to the data input. When the computed checksum for a data input matches the stored value of a previously computed checksum, the probability that the data has not been accidentally altered and/or corrupted is high. Some checksum algorithm techniques include parity byte, sum complement, and position-dependent algorithms. Check digits and parity bits are special cases of checksums that are usually appropriate for small blocks of data. Some error-correcting codes are based on special checksums which not only detect common errors, but the error correcting code in some cases further helps in the recovery of the original data.

“Communication Link” or “Communication Channel” generally refers to a connection between two or more communicating entities and may or may not include a communications channel between the communicating entities. The communication between the communicating entities may occur by any suitable means. For example, the connection may be implemented as an actual physical link, an electrical link, an electromagnetic link, a logical link, or any other suitable linkage facilitating communication. In the case of an actual physical link, communication may occur by multiple components in the communication link configured to respond to one another by physical movement of one element in relation to another. In the case of an electrical link, the communication link may be composed of multiple electrical conductors electrically connected to form the communication link. In the case of an electromagnetic link, elements of the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum. In the case of a logical link, the communication links may be a conceptual linkage between the sender and recipient such as a transmission station in the receiving station. Logical link may include any combination of physical, electrical, electromagnetic, or other types of communication links.

“Communication Node” generally refers to a physical or logical connection point, redistribution point or endpoint along a communication link. A physical network node is generally referred to as an active electronic device attached or coupled to a communication link, either physically, logically, or electromagnetically. A physical node is capable of sending, receiving, or forwarding information over a communication link. A communication node may or may not include a computer, processor, transmitter, receiver, repeater, and/or transmission lines, or any combination thereof.

“Computer” generally refers to any computing device configured to compute a result from any number of input values or variables. A computer may include a processor for performing calculations to process input or output. A computer may include a memory for storing values to be processed by the processor, or for storing the results of previous processing. A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network interface to perform various network communications upon request. A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. A computer may include one or more physical processors or other computing devices or circuitry and may also include any suitable type of memory. A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer. The concept of “computer” and “processor” within a computer or computing device also encompasses any such processor or computing device serving to make calculations or comparisons as part of a disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

“Controller” generally refers to a device, using mechanical, hydraulic, pneumatic electronic techniques, and/or a microprocessor or computer, which monitors and physically alters the operating conditions of a given dynamical system. In one non-limiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus, a controller may include one or more physical processors or other computing devices or circuitry and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using Wi-Fi or other Wireless Local Area Network (WLAN) or a cellular transmitter/receiver to transfer data.

“Conveyor” is used in a broad sense to generally refer to a mechanism that is used to transport something, like an item, box, container, and/or SKU. By way of non-limiting examples, the conveyor can include belt conveyors, wire mesh conveyors, chain conveyors, electric track conveyors, roller conveyors, cross-belt conveyors, vibrating conveyors, and skate wheel conveyors, to name just a few. The conveyor all or in part can be powered or unpowered. For instance, sections of the conveyors can include gravity feed sections.

“Conveyor Zone” or “Zone” generally refers to a section of a conveyor. For example, a conveyor zone includes a section of conveyor driven by a single motorized drive roller (MDR) and/or other types of conveyor motors.

“Cyclic Redundancy Check” or “CRC” generally refers to an error-detecting code or technique to detect errors in digital data. For example, CRC is commonly used in digital networks and/or storage devices to detect accidental changes to raw data. CRC is based on binary division, and CRC is also sometimes referred to as polynomial code checksum. With CRC, blocks of data get encoded with or attached a short check value that is based on the remainder of a polynomial division of the contents of the blocks of data. During retrieval or decoding, the calculation is repeated. When the check values do not match, corrective action can be taken against data corruption. CRCs can be further used to facilitate error correction. The check or data verification value is a redundancy because it expands the message without adding information. CRCs can be simple to implement in binary hardware, easy to analyze mathematically, and are good at detecting common errors caused by noisy transmission channels. Given the check value has a fixed length, the function that generates the check value is sometimes used as a hash function.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour. Data may be organized and represented in a structured format. Examples include a tabular representation using rows and columns, a tree representation with a set of nodes considered to have a parent-children relationship, or a graph representation as a set of connected nodes to name a few. The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Frame” generally refers to the structure which supports the mechanical components of a conveyor and/or sorter that are configured to move items.

“Input/Output (I/O) Device” generally refers to any device or collection of devices coupled to a computing device that is configured to receive input and deliver the input to a processor, memory, or other part of the computing device and/or is controlled by the computing device to produce an output. The I/O device can include physically separate input and output devices, or the input and output devices can be combined together to form a single physical unit. Such input devices of the I/O device can include keyboards, mice, trackballs, and touch sensitive pointing devices such as touchpads or touchscreens. Input devices also include any sensor or sensor array for detecting environmental conditions such as temperature, light, noise, vibration, humidity, and the like. Examples of output devices for the I/O device include, but are not limited to, screens or monitors displaying graphical output, a projecting device projecting a two-dimensional or three-dimensional image, or any kind of printer, plotter, or similar device producing either two-dimensional or three-dimensional representations of the output fixed in any tangible medium (e.g., a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Main Communication Channel” or “Main Communication Link” generally refers to a physical medium (e.g., wires or cables) and/or intangible constructs (e.g., frequencies, addresses, etc.) where normal network communications occur.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Microcontroller” or “MCU” generally refers to a small computer on a single integrated circuit. It may be similar to, but less sophisticated than, a System on a Chip or “SoC”; a SoC may include a microcontroller as one of its components. A microcontroller may contain one or more CPUs (processor cores) along with memory and programmable input/output peripherals. Program memory in the form of ferroelectric RAM, NOR flash or OTP ROM may also be included on the chip, as well as a small amount of RAM. Microcontrollers may be designed for embedded applications, in contrast to the microprocessors used in personal computers or other general-purpose applications consisting of various discrete chips. Microcontrollers may be included in automatically controlled products and devices, such as automobile engine control systems, implantable medical devices, remote controls, office machines, appliances, power tools, toys and other embedded systems. An MCU may be configured to handle mixed signals thus integrating analog components needed to control non-digital electronic systems. Some microcontrollers may use four-bit words and operate at frequencies as low as 4 kHz, for low power consumption (single-digit milliwatts or microwatts). They will generally have the ability to retain functionality while waiting for an event such as a button press or other interrupt; power consumption while sleeping (CPU clock and most peripherals off) may be just nanowatts, making many of them well suited for long lasting battery applications. Other microcontrollers may serve performance roles, where they may need to act more like a Digital Signal Processor (DSP), with higher clock speeds and power consumption. A microcontroller may include any suitable combination of circuits such as: 1. a central processing unit-ranging from small and simple processors with registers as small as 4 bits or list, to complex processors with registers that are 32, 64, or more bits 2. volatile memory (RAM) for data storage 3. ROM, EPROM, EEPROM or Flash memory for program and operating parameter storage 4. discrete input and output bits, allowing control or detection of the logic state of an individual package pin 5. serial input/output such as serial ports (UARTs) 6. other serial communications interfaces like I²C, Serial Peripheral Interface and Controller Area Network for system interconnect 7. peripherals such as timers, event counters, PWM generators, and watchdog 8. clock generator-often an oscillator for a quartz timing crystal, resonator or RC circuit 9. many include analog-to-digital converters, some include digital-to-analog converters 10. in-circuit programming and in-circuit debugging support.

“Motorized Drive Roller” or “MDR” generally refers to a powered conveyor roller with an internally mounted motor that is configured to rotate or spin the roller. The MDR may be controlled via internal and/or external commutation. In one form, the motor for the MDR includes an electric DC motor.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices. Computers coupled to a network may be referred to as “nodes” or as “hosts” and may originate, broadcast, route, or accept data from the network. Nodes can include any computing device such as personal computers, phones, and servers as well as specialized computers that operate to maintain the flow of data across the network, referred to as “network devices”. Two nodes can be considered “networked together” when one device is able to exchange information with another device, whether or not they have a direct connection to each other. Examples of wired network connections may include Digital Subscriber Lines (DSL), coaxial cable lines, or optical fiber lines. The wireless connections may include BLUETOOTH®, Worldwide Interoperability for Microwave Access (WiMAX), infrared channel or satellite band, or any wireless local area network (Wi-Fi) such as those implemented using the Institute of Electrical and Electronics Engineers' (IEEE) 802.11 standards (e.g. 802.11 (a), 802.11 (b), 802.11 (g), or 802.11 (n) to name a few). Wireless links may also include or use any cellular network standards used to communicate among mobile devices including 1G, 2G, 3G, 4G, or 5G. The network standards may qualify as 1G, 2G, etc. by fulfilling a specification or standards such as the specifications maintained by the International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced. Cellular network standards may use various channel access methods such as FDMA, TDMA, CDMA, or SDMA. Different types of data may be transmitted via different links and standards, or the same types of data may be transmitted via different links and standards. The geographical scope of the network may vary widely. Examples include a Body Area Network (BAN), a Personal Area Network (PAN), a Local-Area Network (LAN), a Metropolitan Area Network (MAN), a Wide Area Network (WAN), or the Internet. A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

“Optionally” means discretionary; not required; possible, but not compulsory; left to personal choice.

“Photoeye”, “PE”, or “Photoelectric Sensor” generally refers to a device configured to detect the presence, absence, and/or distance of an object with a light transmitter (or emitter) and a photoelectric receiver. In one form, the emitter and receiver are integrated to form a single unit, and in another form, the emitter and receiver are separate components. Photoeyes can be generally categorized into three different types, opposed (through-beam), retro-reflective, and proximity-sensing (diffused) types.

“Predominately” is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement. The concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, and the unknown number may automatically change over time as well. The concept of a “processor” includes a device configured or programmed to make threshold comparisons, rules comparisons, calculations, or perform logical operations applying a rule to data yielding a logical result (e.g., “true” or “false”). Processing activities may occur in multiple single processors on separate servers, on multiple processors in a single server with separate processors, or on multiple processors physically remote from one another in separate computing devices.

“Roller” generally refers to a cylindrically shaped material handling component that is able to revolve. Typically, but not always, the roller is configured to provide mechanical power transmission, a conveying surface, and/or support for conveyed objects or items. The roller can be powered or unpowered.

“Sideband Communication” generally refers to a communication protocol or technique where normal network communications are transmitted as well as other services are provided via a main communication channel and where a separate communication channel (or sideband channel) is used to facilitate separate peer to peer communications. The sideband communication can occur in wired and/or wireless networks. For example, in a wired Ethernet network environment, normal controller area network communications can occur in the standard wires that form the main communication channel used for normal network communication and the sideband communication channel can exist on the unused wires for the main Ethernet communication protocol. For instance, the sideband communications can occur using a serial RJ485 standard. In wireless networks, the main communication channel is typically associated with a carrier frequency, and the sideband communications can occur on the lower sideband (USB) or the upper sideband (USB) lobe frequencies around the carrier frequency. In other examples where the wireless communication is digital, different addresses or other signifiers can be used to delineate the main and sideband communication channels.

“Sideband Communication Channel” or “Sideband Communication Link” generally refers to a physical medium (e.g., wires or cables) and/or intangible constructs (e.g., frequencies, addresses, etc.) where communications outside normal network communications occur. The sideband communication channel is separate and distinct from the main communication channel on a given network such that communications on the sideband communication channel have no impact on communications on the main communication channel.

“Stock Keeping Unit” (SKU) or “Item” generally refers to an individual article or thing. The SKU can come in any form and can be packaged or unpackaged. For instance, SKUs can be packaged in cases, cartons, bags, drums, containers, bottles, cans, pallets, and/or sacks, to name just a few examples. The SKU is not limited to a particular state of matter such that the item can normally have a solid, liquid, and/or gaseous form for example.

“Storage Container” generally refers to an object that can be used to hold or transport SKUs or other objects. By way of non-limiting examples, the storage container can include cartons, totes, pallets, bags, and/or boxes.

“Storage Facility” generally refers to a location for keeping and/or storing items or goods. A storage facility may keep the items or goods indoors or outdoors. As an example, a storage facility may be a large building, such as a warehouse, or may be an outdoor area that is either open or enclosed by a fence or by another suitable method.

“Substantially” generally refers to the degree by which a quantitative representation may vary from a stated reference without resulting in an essential change of the basic function of the subject matter at issue. The term “substantially” is utilized herein to represent the inherent degree of uncertainty that may be attributed to any quantitative comparison, value, measurement, and/or other representation.

“Transceiver” generally refers to a device that includes both a transmitter and a receiver that share common circuitry and/or a single housing. Transceivers are typically, but not always, designed to transmit and receive electronic signals, such as analog and/or digital radio signals.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

Reference Numbers

| | |
|---|---|
| 100 | conveyor system |
| 105 | warehouse management system |
| 110 | programmable logic controllers |
| 115 | conveyor zone |
| 120 | controller card |
| 125 | communication cable |
| 130 | leader card |
| 200 | conveyor system |
| 205 | conveyor |
| 206 | frame |
| 207 | rails |
| 208 | rollers |
| 210 | first zone |
| 215 | second zone |
| 220 | third zone |
| 225 | first controller card |
| 230 | third controller card |
| 240 | packages |
| 242 | main communication channel |
| 245 | sideband communication channel |
| 250 | photoeye |
| 300 | power system |
| 305 | bus power |
| 310 | switch |
| 320 | conveyor power connector |
| 322 | current sensor |
| 325 | regulator |
| 330 | photoeye |
| 335 | light emitting diode |
| 340 | brake |
| 345 | chopper |
| 350 | logic power |
| 355 | power path selector |
| 400 | communication system |
| 405 | upstream port |
| 410 | downstream port |
| 415 | motor control unit |
| 420 | first network carrier transceiver |
| 425 | upstream sideband transceiver |
| 427 | downstream sideband transceiver |
| 428 | first carrier network connection |
| 429 | sideband connections |
| 430 | second network carrier transceiver |
| 431 | second carrier network |
| 432 | motor control unit carrier link |
| 433 | motor control unit sideband link |
| 435 | first electrical device |
| 440 | second electrical device |
| 442 | direct conveyor connection |
| 445 | termination resistor |
| 450 | CAN gateway |
| 500 | sideband communication system |
| 510 | first controller card |
| 520 | second controller card |
| 605 | channel |
| 610 | access panel |
| 705 | groove |
| 710 | track |
| 805 | circuit board |
| 810 | upstream port |
| 815 | downstream port |
| 905 | main board |
| 910 | secondary board |
| 1005 | fastener |
| 1100 | communication wiring diagram |
| 1105 | upstream controller |
| 1110 | downstream controller |
| 1115 | control area network (CAN) controller |
| 1200 | zone termination wiring diagram |
| 1205 | upstream detection circuit |
| 1210 | downstream detection circuit |
| 1215 | upstream communication circuit |
| 1220 | downstream communication circuit |
| 1300 | flowchart |
| 1302 | card addressing process |
| 1305 | stage |
| 1310 | stage |
| 1315 | stage |
| 1320 | stage |
| 1325 | stage |
| 1330 | stage |
| 1335 | stage |
| 1400 | flowchart |
| 1402 | parameter propagation process |
| 1405 | stage |
| 1410 | stage |
| 1415 | stage |
| 1420 | stage |
| 1425 | stage |
| 1500 | flowchart |
| 1502 | failure detection process |
| 1505 | stage |
| 1510 | stage |
| 1515 | stage |
| 1520 | stage |
| 1600 | flowchart |
| 1602 | settings transfer process |
| 1605 | stage |
| 1610 | stage |
| 1615 | stage |
| 1620 | stage |
| 1700 | flowchart |
| 1702 | package tracking process |
| 1705 | stage |
| 1710 | stage |
| 1715 | stage |
| 1720 | stage |
| 1725 | stage |
| 1730 | stage |
| 1735 | stage |
| 1740 | stage |
| 1800 | user interface |
| 1805 | card connection button |
| 1810 | firmware flash button |
| 1815 | testing button |
| 1820 | conveyor settings |
| 1900 | testing interface |
| 1905 | first motorized drive roller |
| 1910 | second motorized drive |
| 2000 | system |
| 2005 | network |
| 2010 | operator computer |
| 2015 | chains |
| 2020 | first chain |
| 2025 | second chain |
| 2100 | user interface |
| 2105 | card address |
| 2110 | chain identifier |
| 2115 | card identifier |
| 2120 | leader card checkbox |
| 2125 | firmware version box |
| 2200 | system |
| 2205 | enabled chain |
| 2210 | disabled chain |
| 2300 | log screen |
| 2305 | message body |
| 2310 | message length |
| 2400 | flowchart |
| 2405 | stage |
| 2410 | stage |
| 2415 | stage |
| 2500 | system |
| 2505 | zones |
| 2510 | communication cable |
| 2515 | termination resistor |
| 2520 | motorized drive roller |
| 2525 | zone sensor |
| 2530 | bypassed zone |
| 2535 | active zone |
| 2600 | flowchart |
| 2605 | stage |
| 2610 | stage |
| 2615 | stage |
| 2700 | flowchart |
| 2705 | stage |
| 2710 | stage |
| 2715 | stage |
| 2720 | stage |
| 2800 | user interface |
| 2805 | control button |
| 2810 | select button |
| 2815 | increment button |
| 2820 | counterclockwise indicator |
| 2825 | clockwise indicator |
| 2905 | output configuration button |
| 2910 | motorized drive roller indicator |
| 2915 | sensor indicator |
| 3000 | user interface |
| 3005 | selection pane |
| 3010 | action area |
| 3015 | log pane |
| 3020 | selection box |
| 3025 | mode selector |
| 3030 | open file button |
| 3035 | begin button |
| 3040 | stop button |
| 3045 | export button |
| 3100 | diagram |
| 3105 | first branch |
| 3110 | second branch |
| 3115 | stage |
| 3120 | stage |
| 3125 | stage |
| 3130 | stage |
| 3135 | stage |
| 3140 | stage |
| 3145 | stage |
| 3150 | stage |
| 3155 | stage |
| 3200 | diagram |
| 3205 | canary branch |
| 3210 | follower branch |
| 3215 | stage |
| 3220 | stage |
| 3225 | stage |
| 3230 | stage |
| 3235 | stage |
| 3240 | stage |
| 3245 | stage |
| 3250 | stage |
| 3255 | stage |
| 3260 | stage |
| 3265 | stage |
| 3270 | stage |
| 3300 | user interface |
| 3305 | reset option |
| 3310 | neighbor |
| 3315 | select |
| 3320 | clear |
| 3325 | update |
| 3400 | flowchart |
| 3405 | stage |
| 3410 | stage |
| 3415 | stage |
| 3420 | stage |
| 3425 | stage |
| 3430 | stage |
| 3435 | stage |
| 3440 | stage |

What is claimed is:

1. A conveyor system, comprising:
one or more controller cards that are dedicated to control individual conveyor zones;
a network operatively connected to the controller cards; and
wherein the controller cards are configured to reduce congestion on the network.

2. The conveyor system of claim 1, wherein the controller cards are configured to provide unsolicited feedback messages over the network.

3. The conveyor system of claim 2, wherein the controller cards have a unique card address that includes a chain identifier and a card identifier.

4. The conveyor system of claim 1, wherein the controller cards are configured to operate in a follow-me mode.

5. The conveyor system of claim 4, wherein:
the controller cards include a leader controller card and one or more follower controller cards connected in a chain; and
the follower controller cards are configured to follow operation instructions from the leader controller card.

6. The conveyor system of claim 5, wherein the follower controller cards are configured to delay operation initiation by a delay value to avoid electrical overloads.

7. The conveyor system of claim 1, wherein the controller cards have a zero-index mode where the controller cards are prevented from indexing upon bootup.

8. The conveyor system of claim 1, wherein the controller cards are configured to allow global programming via the network.

9. The conveyor system of claim 8, wherein the global programming includes flashing firmware on the controller cards.

10. The conveyor system of claim 8, wherein the global programming includes performing resets of the controller cards.

11. The conveyor system of claim 8, wherein the global programming is configured to occur in a parallel manner.

12. The conveyor system of claim 1, wherein:
the controller cards have a jammed zone self-recovery mode; and
the jammed zone self-recovery mode includes an operational time limit, a wait time limit, and a number of attempts limit.

13. A method, comprising:
monitoring a status of a conveyor zone with a controller card;
determining a change in the status of the conveyor zone with the controller card; and
sending a message from the controller card over a network in response to the determining the change in the status of the conveyor zone.

14. The method of claim 13, wherein the monitoring the status of the conveyor zone includes monitoring the conveyor zone with a zone sensor.

15. The method of claim 13, further comprising:
receiving at least one packet from the network that programs the controller card to communicate via an unsolicited feedback mode before the sending the message.

16. A method, comprising:
receiving a selection of two or more selected controller cards of a conveyor system;
sending one or more packets over a network to the selected controller cards; and
programming the selected control cards based on the packets from the network.

17. The method of claim 16, wherein the programming includes performing firmware updates of the selected controller cards.

18. The method of claim 16, wherein the programming includes performing memory resets of the selected controller cards.

19. The method of claim 18, wherein the programming includes performing neighbor restores of the selected controller cards.

20. The method of claim 16, wherein the programming includes designating the selected controller cards as communicating via an unsolicited feedback mode.

21. The method of claim 16, wherein:
the sending includes addressing the packets to unique addresses for the selected controller cards; and
the programming the selected control cards occurs in a sequential manner.

22. The method of claim 16, wherein:
the sending includes addressing the packets to a global address; and
the programming the selected control cards occurs in a parallel manner.
